(19) United States
(12) Patent Application Publication
(10) Pub. No.: US 2021/0124854 A1
(43) Pub. Date: Apr. 29, 2021

(54) SYSTEMS AND METHODS FOR ENHANCED POWER SYSTEM MODEL PARAMETER ESTIMATION

(71) Applicant: General Electric Company, Schenectady, NY (US)

(72) Inventors: Honggang Wang, Clifton Park, NY (US); Kaveri Mahapatra, State College, PA (US)

(21) Appl. No.: 16/665,788

(22) Filed: Oct. 28, 2019

(51) Int. Cl. G06F 30/20

(52) U.S. Cl. CPC G06F 30/20; G06F 30/27

(57) ABSTRACT

A system for enhanced sequential power system model calibration is provided. The system is programmed to receive event data and model response data associated with a model to simulate. The system is also programmed to identify a first region of a first event, determine a first weight for the first region, and assign a second weight to a second region of the first event. The first region and the second region are different. The first weight and the second weight are different. The system is further programmed to evaluation the model based on the first event including the first weight and the second weight.

### STATEMENT REGARDING FEDERALLY SPONSORED RESEARCH & DEVELOPMENT

This invention was made with government support under U.S. Government Contract Number: DE-OE0000858 awarded by the Department of Energy. The government has certain rights in the invention.

### BACKGROUND

The field of the invention relates generally to power system model validation and calibration, and more particularly, to a system for modeling power systems based on multiple events.

During the 1996 Western System Coordinating Council (WSCC) blackout, planning studies conducted using dynamic models had predicted stable system operation, whereas the real system became unstable in a few minutes with severe swings. To ensure the models represent the real system accurately, the North American Electric Reliability Coordinator (NERC) requires generators above 20 MVA to be tested every 5 years or 10 years (depending on their interconnection) to check the accuracy of dynamic models and update the power plant dynamic models as necessary.

Some of the methods of performing calibration on the model include performing staged tests and direct measurement of disturbances. In a staged test, a generator is first taken offline from normal operation. While the generator is offline, the testing equipment is connected to the generator and its controllers to perform a series of predesigned tests to derive the desired model parameters. This method may cost $15,000-$35,000 per generator per test in the United States and includes both the cost of performing the test and the cost of taking the generator offline. Phasor Measurement Units (PMUs) and Digital Fault Recorders (DFRs) have seen dramatic increasing installation in recent years, which allows for non-invasive model validation by using the sub-second-resolution dynamic data. Varying types of disturbances across locations in the power system along with large installed base of PMUs makes it possible to validate the dynamic models of the generators frequently at different operating conditions.

One common practice during model validation and calibration is to evaluate the curve fitting result between measured and simulated response for both active power P and reactive power Q. Some regions of interest in an event may not fit very well, even though the overall curve fitting error is small. Those regions include, but are not limited to the peak area, a curve rising area, and an oscillation area. Furthermore, sometimes there are long sections of steady state data, which has little dynamic information. If not used properly, these sections will add unnecessary calculation time and burden, and they also tend to lead to a worse curve fitting result and model parameters. In addition, there is the potential for significant deviations between simulated and measured active power, while the simulated and measured reactive power match closely, and vice versa. Accordingly, there exists a need for additional accuracy and flexibility in curve fitting for model calibration.

### BRIEF DESCRIPTION

In one aspect, a system for enhanced power system model calibration is provided. The system includes a computing device including at least one processor in communication with at least one memory device. The at least one processor is programmed to receive event data and model response data associated with a model to simulate. The at least one processor is also programmed to identify a first region of a first event. The at least one processor is further programmed to determine a first weight for the first region. In addition, the at least one processor is programmed to assign a second weight to a second region of the first event. The first region and the second region are different. The first weight and the second weight are different. Moreover, the at least one processor is programmed to evaluate the model based on the first event including the first weight and the second weight.

In another aspect, a method for enhanced power system model calibration is provided. The method is implemented on a computing device including at least one processor in communication with at least one memory device. The method includes receiving event data and model response data associated with a model to simulate. The method also includes identifying a first region of a first event. The first event includes an active power curve and a reactive power curve. The method further includes determining a first weight for a first portion of the first region. The first region includes a plurality of points in time. The first weight is associated with a first portion of the plurality of points in time. In addition, the method includes determining a second weight for a second portion of the first region. The first weight and the second weight are different. The first portion is associated with the active power curve and the second portion is associated with reactive power curve. Moreover, the method includes evaluating the model based on the first event including the first portion and the first weight and the second portion and the second weight.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a block diagram of a power distribution grid.

FIG. 2 illustrates a high-level block diagram of a system for performing sequential calibration in accordance with some embodiments.

FIG. 3 illustrates a block diagram of exemplary system architecture for power system model calibration, in accordance with one embodiment of the disclosure.

FIG. 4 illustrates a process for power system model parameter conditioning in accordance with some embodiments.

FIG. 5 illustrates a process for enhanced power system model calibration, in accordance with at least one embodiment.

FIG. 6 illustrates a process for identifying and weighting features of events, in accordance with one embodiment.

FIGS. 7A-7F illustrate a plurality of graphs of events with highlighted features in accordance with at least one embodiment.

FIG. 8 illustrates a process for detecting a dynamic data segment of an event for analysis in accordance with at least one embodiment.

FIG. 9 illustrates another process for detecting a dynamic data segment of an event for analysis in accordance with at least one embodiment

FIG. 10 illustrates a plurality of processes for identifying and estimating parameters using variations of the process shown in FIG. 6.

FIGS. 11A and 11B illustrate a process for identifying and estimating parameters in accordance with at least one embodiment.

FIGS. 12A and 12B illustrate exemplary user interfaces for adjusting a region and its corresponding weights for calibration in accordance with at least one embodiment.

FIG. 13 is a diagram illustrating candidate parameter estimation algorithms in accordance with some embodiments.

FIG. 14 illustrates a two-stage approach of the process for model calibration.

FIG. 15 is a diagram illustrating an exemplary apparatus or platform according to some embodiments.

FIGS. 16A and 16B illustrate exemplary graphs of active and reactive power before and after calibration using the system shown in FIG. 3.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “power system simulation” refers to power system modeling and network simulation in order to analyze electrical power systems using design/offline or real-time data. Power system simulation software is a class of computer simulation programs that focus on the operation of electrical power systems. This type of computer programs are used in a wide range of planning and operational situations for example: electric power generation—nuclear, conventional, renewable, commercial facilities, utility transmission, and utility distribution. Applications of power system simulation include, but are not limited to: long-term generation and transmission expansion planning, short-term operational simulations, and market analysis (e.g. price forecasting). A traditional simulation engine relies on differential algebraic equations (DAEs) therein to represent the relationship between voltage, frequency, active power and reactive power. Those mathematical relationships may be used to study different power systems applications including, but not limited to: load flow, short circuit or fault analysis, protective device coordination, discrimination or selectivity, transient or dynamic stability, harmonic or power quality analysis and optimal power flow.

As used herein, the term “power system devices” refers to devices that the simulation engine or simulation model represent may include: transmission systems, generating units, and loads. Transmission systems include, but are not limited to, transmission lines, power transformers, mechanically switched shunt capacitors and reactors, phase-shifting transformers, static VAR compensators (SVC), flexible AC transmission systems (FACTS), and high-voltage dc (HVDC) transmission systems. The models may include equipment controls such as voltage pick-up and drop-out levels for shunt reactive devices. Generating units include the entire spectrum of supply resources—hydro-, steam-, gas-, and geothermal generation along with rapidly emerging wind and solar power plants. The load represents the electrical load in the system, which range from simple light-bulbs to large industrial facilities.

As used herein, the term “model validation” is defined within regulatory guidance as “the set of processes and activities intended to verify that models are performing as expected, in line with their design objectives, and business uses.” It also identifies “potential limitations and assumptions, and assesses their possible impact.” In the power system context, the model validation assures that the model accurately represents the operation of the real system—including model structure, correct assumptions, and that the output matches actual events. There is a reason behind model validation for a power system asset. The behavior of power plants and electric grids change over time and should be checked and updated to assure that they remain accurate.

The purpose of model validation is to understand the underlying power system phenomena so they can be appropriately represented in power system studies. The eventual goal of the systems described herein is to generate a total system model that can reasonably predict the outcome of an event. However, to achieve this, the individual constituents of the system model need to be valid. The process of model validation and the eventual “validity” of the model require sound “engineering judgment” rather than being based on a simple pass/fail of the model determined by some rigid criteria. This is because any modeling activity necessitates certain assumptions and compromises, which can only be determined by a thorough understanding of the process being modeled and the purpose for which the model is to be used. Component-level model validation can be done either through staged tests or on-line disturbance based model validation.

As used herein, the term “model calibration” refers to adjustments of the model parameters to improve the model so that the model's response will match the real, actual, or measured response, given the same model input. Once the model is validated, a calibration process is used to make minor adjustments to the model and its parameters so that the model continues to provide accurate outputs. High-speed, time synchronized data, collected using phasor measurement units (PMUs), are used for model validation of the dynamic response to grid events.

As used herein, the term “Phasor Measurement Unit” (PMU) refers to a device used to estimate the magnitude and phase angle of an electrical phasor quantity (such as voltage or current) in the electricity grid using a common time source for synchronization. Time synchronization is usually provided by GPS and allows synchronized real-time measurements of multiple remote points on the grid. PMUs are capable of capturing samples from a waveform in quick succession and reconstructing the phasor quantity, made up of an angle measurement and a magnitude measurement. The resulting measurement is known as a synchrophasor. These time synchronized measurements are important because if the grid's supply and demand are not perfectly matched, frequency imbalances can cause stress on the grid, which is a potential cause for power outages.

PMUs may also be used to measure the frequency in the power grid. A typical commercial PMU may report measurements with very high temporal resolution in the order of 30-60 measurements per second. Engineers use this in analyzing dynamic events in the grid which is not possible with traditional SCADA measurements that generate one measurement every 2 or 4 seconds. Therefore, PMUs equip utilities with enhanced monitoring and control capabilities and are considered to be one of the most important measuring devices in the future of power systems. A PMU can be a dedicated device, or the PMU function can be incorporated into a protective relay or other device.

As used herein, the terms “power grid disturbance” and “power grid event” refer to outages, forced or unintended disconnection, or failed re-connection of breaker as a result of faults in the power grid. A grid disturbance starts with a primary fault and may also consist of one or more secondary faults or latent faults. A grid disturbance may, for example, be: a tripping of breaker because of lightning striking a line; a failed line connection when repairs or adjustments need to be carried out before the line can be connected to the network; an emergency disconnection due to fire; an undesired power transformer disconnection because of faults due to relay testing; and tripping with a successful high-speed automatic reclosing of a circuit breaker.

The feature of an event may comprise peak value, bottom value, overshoot percentage, a rising time, a settling time, delay time, peak time, steady state error, a phase shift, a damping ratio, an energy function, and a cumulative deviation in energy, Fourier transformation spectrum information, frequency response, principal component, minimum volume ellipsoid, steady state gain (P, Q, u, f), of the event. The feature is extracted from the time series of active power, reactive power, voltage and frequency.

PMU recordings of almost any noticeable grid event can be used for model validation. During grid disturbances, a device operates outside of its normal steady-state condition, providing an opportunity to observe the dynamic behavior of the asset during transients. The PMU data from these transient grid disturbances provides information that cannot be captured with SCADA. These transient disturbances often pose the most risk for grid stability and reliability. Some of the grid events that may generate valuable PMU data for model validation purposes include, but are not limited to:

Frequency excursion events—In a frequency excursion event, a substantial loss of load or generation causes a significant shift in electrical frequency, typically outside an interconnection's standard. PMU data on a generator's response to a frequency excursion may be used to examine the settings and performance of models of governor and automatic generation control (used to adjust the power output of a generator in response to changes in frequency).

Voltage excursion events—A fault on the system, a significant change in load or generation (including intermittent renewables), or the loss of a significant load or generation asset can cause voltage shifts. PMU data on a generator's response to a voltage excursion can be used to validate models of its excitation system, reactive capabilities, and automated voltage regulation settings (used to control the input voltage for the exciter of a generator to stabilize generator output voltage).

Device trips—Transmission devices and lines routinely trip out of service. They cause less severe impacts than a frequency or voltage excursion, but can provide similar data sets useful for model validation.

Remedial Action Scheme (RAS) activations—Useful data events for model validation can be caused by a reaction to mitigate grid disturbances. Certain grid disturbances may cause a RAS activation, which will attempt to regulate the grid back to a normal operating condition. In some systems, the RAS may include switching on devices such as shunt reactors, changing FACTS devices, or inserting braking resistance. Activation of the RAS may create additional discrete disturbance events on the system, providing frequency and voltage events that can also be used for model validation.

Probing signals—In the WECC, the high-voltage direct current (HVDC) station at Celilo, Oreg., has the ability to modulate its output power to a known signal, effectively serving as a signal generator into the western power system. These signals can be used to verify and calibrate system-level and generator models' frequency responses, particularly for small-signal-stability analysis.

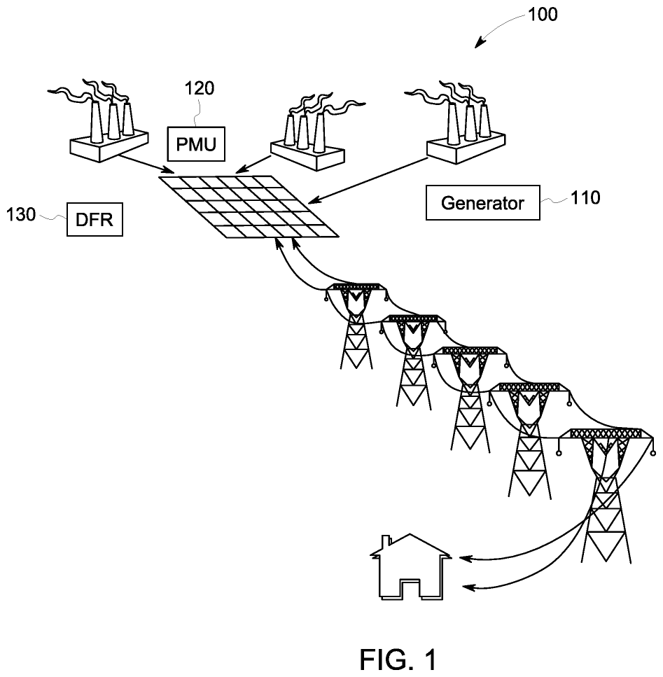

FIG. 1 illustrates a power distribution grid 100. The grid 100 includes a number of components, such as power generators 110. In some cases, planning studies conducted using dynamic models predict stable grid 100 operation, but the actual grid 100 may become unstable in a few minutes with severe swings (resulting in a massive blackout). To ensure that the models represent the real system accurately, the North American Electric Reliability Coordinator (“NERC”) requires generators 110 above 10 MVA to be tested every five years to check the accuracy of dynamic models and let the power plant dynamic models be updated as necessary. The systems described herein consider not only active power (P) and reactive power (Q) but also voltage (U) and frequency (F).

In a typical staged test, a generator 110 is first taken offline from normal operation. While the generator 110 is offline, testing equipment is connected to the generator 110 and its controllers to perform a series of pre-designed tests to derive the desired model parameters. Recently, PMUs 120 and Digital Fault Recorders (“DFRs”) 130 have seen dramatic increasing installation in recent years, which may allow for non-invasive model validation by using the sub-second-resolution dynamic data. Varying types of disturbances across locations in the grid 100 along with the large installed base of PMUs 120 may, according to some embodiments, make it possible to validate the dynamic models of the generators 110 frequently at different operating conditions. There is a need for a production-grade software tool generic enough to be applicable to wide variety of models (traditional generating plant, wind, solar, dynamic load, etc. with minimal changes to existing simulation engines. Note that model calibration is a process that seeks multiple (dozens or hundreds) of model parameters, which could suffer from local minimum and multiple solutions. There is need for an algorithm to enhance the quality of a solution within a reasonable amount time and computation burdens.

Online performance monitoring of power plants using synchrophasor data or other high-resolution disturbance monitoring data acts as a recurring test to ensure that the modeled response to system events matches actual response of the power plant or generating unit. From the Generator Owner (GO)'s perspective, online verification using high resolution measurement data can provide evidence of compliance by demonstrating the validity of the model by online measurement. Therefore, it is a cost-effective approach for GO as they may not have to take the unit offline for testing of model parameters. Online performance monitoring requires that disturbance monitoring equipment such as a PMU be located at the terminals of an individual generator or Point of Interconnection (POI) of a power plant.

The disturbance recorded by PMU normally consists of four variables: voltage, frequency, active power, and reactive power. To use the PMU data for model validation, the playback simulation has been developed and they are now available in all major grid simulators. The simulated output including active power and reactive power will be generated and can be further compared with the measured active power and reactive power.

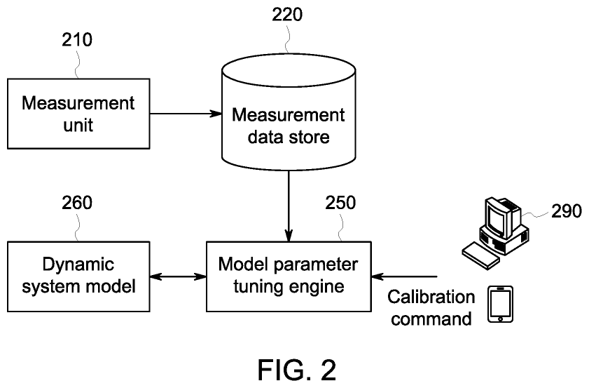

To achieve such results, FIG. 2 is a high-level block diagram of a system 200 in accordance with some embodiments. The system 200 includes one or more measurement units 210 (e.g., PMUs, DFRs, or other devices to measure frequency, voltage, current, or power phasors) that store information into a measurement data store 220. As used herein, the term “PMU” might refer to, for example, a device used to estimate the magnitude and phase angle of an electrical phasor quantity like voltage or current in an electricity grid using a common time source for synchronization. The term “DFR” might refer to, for example, an Intelligent Electronic Device (“TED”) that can be installed in a remote location, and acts as a termination point for field contacts. According to some embodiments, the measurement data might be associated with disturbance event data and/or data from deliberately performed unit tests. According to some embodiments, a model parameter tuning engine 250 may access this data and use it to tune parameters for a dynamic system model 260. The process might be performed automatically or be initiated via a calibration command from a remote operator interface device 290. As used herein, the term “automatically” may refer to, for example, actions that can be performed with little or no human intervention.

Note that power systems may be designed and operated using mathematical models (power system models) that characterize the expected behavior of power plants, grid elements, and the grid as a whole. These models support decisions about what types of equipment to invest in, where to put it, and how to use it in second-to-second, minute-to-minute, hourly, daily, and long-term operations. When a generator, load, or other element of the system does not act in the way that its model predicts, the mismatch between reality and model-based expectations can degrade reliability and efficiency. Inaccurate models have contributed to a number of major North American power outages.

The behavior of power plants and electric grids may change over time and should be checked and updated to assure that they remain accurate. Engineers use the processes of validation and calibration to make sure that a model can accurately predict the behavior of the modeled object. Validation assures that the model accurately represents the operation of the real system—including model structure, correct assumptions, and that the output matches actual events. Once the model is validated, a calibration process may be used to make minor adjustments to the model and its parameters so that the model continues to provide accurate outputs. High-speed, time-synchronized data, collected using PMUs may facilitate model validation of the dynamic response to grid events. Grid operators may use, for example, PMU data recorded during normal plant operations and grid events to validate grid and power plant models quickly and at lower cost.

The transmission operators or regional reliability coordinators, or Independent System Operators, like MISO, ISO-New England, PG&E, can use this calibrated generator or power system model for power system stability study based on N-k contingencies, in every 5 to 10 minutes. If there is stability issue (transient stability) for some specific contingency, the power flow will be redirected to relieve the stress-limiting factors. For example, the output of some power generators will be adjusted to redirect the power flow. Alternatively, adding more capacity (more power lines) to the existing system can be used to increase the transmission capacity.

With a model that accurately reflects oscillations and their causes, the grid operator can also diagnose the causes of operating events, such as wind-driven oscillations, and identify appropriate corrective measures before those oscillations spread to harm other assets or cause a loss of load.

As used herein, devices, including those associated with the system 200 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The model parameter tuning engine 250 may store information into and/or retrieve information from various data stores, which may be locally stored or reside remote from the model parameter tuning engine 250. Although a single model parameter tuning engine 250 is shown in FIG. 2, any number of such devices may be included. Moreover, various devices described herein might be combined according to embodiments of the present invention. For example, in some embodiments, the measurement data store 220 and the model parameter tuning engine 250 might comprise a single apparatus. The system 200 functions may be performed by a constellation of networked apparatuses, such as in a distributed processing or cloud-based architecture.

A user may access the system 200 via the device 290 (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., when a new electrical power grid component is calibrated) and/or provide or receive automatically generated recommendations or results from the system 200.

The example embodiments provide a predictive model which can be used to replace the dynamic simulation engine when performing the parameter identification and the parameter calibration. The model can be trained based on historical behavior of a dynamic simulation engine thereby learning patterns between inputs and outputs of the dynamic simulation engine. The model can emulate the functionality performed by the dynamic simulation engine without having to perform numerous rounds of simulation. Instead, the model can predict (e.g., via a neural network, or the like) a subset of parameters for model calibration and also predict/estimate optimal parameter values for the subset of parameters in association with a power system model that is being calibrated. According to the examples herein, the model may be used to capture both input-output function and first derivative of a dynamic simulation engine used for model calibration. The model may be updated based on its confidence level and prediction deviation against the original simulation engine.

Here, the model may be a surrogate for a dynamic simulation engine and may be used to perform model calibration without using DAE equations. The system described herein may be a model parameter tuning engine, which is configured to receive the power system data and model calibration command, and search for the optimal model parameters using the surrogate model until the closeness between simulated response and the real response from the power system data meet a predefined threshold. In the embodiments described herein, the model operates on disturbance event data that includes one or more of device terminal real power, reactive power, voltage magnitude, and phase angle data. The model calibration may be triggered by user or by automatic model validation step. In some aspects, the model may be trained offline when there is no grid event calibration task. The model may represent a set of different models used for different kinds of events. In some embodiments, the model's input may include at least one of voltage, frequency and other model tunable parameters. The model may be a neural network model, fuzzy logic, a polynomial function, and the like. Other model tunable parameters may include a parameter affecting dynamic behavior of machine, exciter, stabilizer and governor. Also, the surrogate model's output may include active power, reactive power or both. In some cases, the optimizer may be gradient based method including Newton-like methods. For example, the optimizer may be gradient free method including pattern search, genetic algorithm, simulated annealing, particle swarm optimizer, differential evolution, and the like.

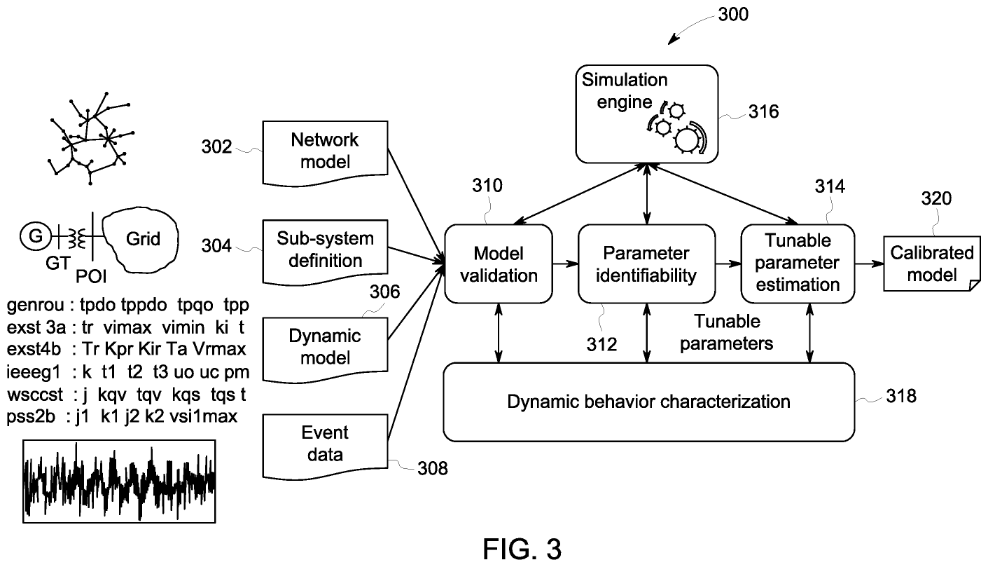

FIG. 3 illustrates a block diagram of exemplary system architecture 300 for power system model calibration, in accordance with one embodiment of the disclosure. In the exemplary embodiment, the system architecture 300 receives network models 302, sub-system definitions 304, dynamic models 306, and event data 308.

Steady state network models 302 (sometimes called as power-flow data) can be either EMS or system planning models. In some embodiments, they may be in e-terra NETMOM or CIM13 format. Dynamic models 306 can be in either PSS/E or PSLF or TSAT format. The system 300 can also accept more than one dynamic data file when data is distributed among multiple files. In the exemplary embodiment, the network models 302 and the dynamic models 306 use the same naming convention for the network elements.

In the exemplary embodiment, the sub-system definitions 304 are based on the network model 302 and one or more maps of the power plant. A sub-system identification module combines the network model 302 and the one or more maps to generate the sub-system definition 304. In some embodiments, the sub-system definition 304 is provided via an XML file that defines the POI(s) and generators that makes up a power plant. Power plants are defined by generators in the plant with its corresponding POI(s). A few examples of power plant sub-system definitions are listed below in TABLE 1.

TABLE 1

| Sub- | | | |
|---|---|---|---|
| system | | | |
| name | Sub-system | POI(s) | Generator(s) |
| S1 | 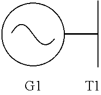 | T1 | G1 |
| S2 | 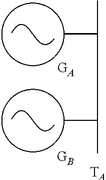 | T_{A} | G_{A} G_{B} |
| S3 | 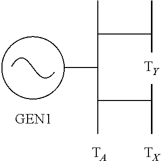 | T_{X} T_{Y} | GEN1 |

In the exemplary embodiment, the system 300 provides a user interface to facilitate defining the power plant starting from a potential POI. Potential POIs are identified as terminals/buses in the system having all required measurements (V, f, P, Q) to perform model validation and calibration. A measurement mapping module identifies terminals with V, f, P, Q measurements and lets the user search for radially connected generators starting from potential POIs. Sub-system definitions 304 may also be saved for future use. In some embodiments, a sub-system definition 304 is defined for each event 308.

Events 308 are where the voltage and/or the frequency of the power system changes. For example, an event 308 may be a generator turning on. In some embodiments, the event 308 has the same or similar attributes to a previous event 308, such as that same generator turning on, the event 308 is skipped to reduce redundant processing. In the exemplary embodiment, the event data or Phasor data 308 will be imported from a variety of sources, such as, but not limited to, e-terraphasorpoint, openPDC, CSV files, COMTRADE files and PI historian. In the exemplary embodiment, the POIs will have at least voltage, frequency, real power and reactive power measurements. In some embodiments, voltage angle is substituted for frequency.

The network models 302, sub-system definitions 304, dynamic models 306, and event data 308 are analyzed by the system 300 as described herein. In the exemplary embodiment disclosed herein, the model utilizes multiple disturbance events to validate and calibrate power system models for compliance with NERC mandated grid reliability requirements.

More specifically, the network models 302, sub-system definitions 304, dynamic models 306, and event data 308 are analyzed and validated by the model validation component 310. If the models are validated, then the corresponding data is sent to a parameter identifiability component 312. This component 312 analyzes the event and models to determine which parameters are significant for this event 308. Then the tunable parameters are transmitted to a tunable parameter estimation component 314, which further analyzes the significant parameters to calibrate the parameters in the model being executed by the simulation engine 316. In the exemplary embodiment, the model validation component 310, the parameter identifiability component 312, and the tunable parameter estimation component 314 are all in communication with a dynamic behavior characterization component 318, which extracts features from the events 308, generates weights for those features, and provides the user the ability to fine tune the model calibration and add subject matter expert knowledge to the model calibration process. The end result is a fully calibrated model 320. The steps in this process are further described below.

In the exemplary embodiment, the model validation component 310 validates the models 302 and 306 and definitions 304 that are being input into the system 300. In at least one embodiment, a typical synchronous generator model has four parts: machine model, turbine-governor model, excitation model and power system stabilizer (PSS) model. The model validation component 310 validates the provided models based on a collection of published NERC List of Acceptable Models, user preferences, and historical data. In some embodiments, there may also be prohibited model lists that are evaluated. Furthermore, units with a power system stabilizer (PSS) should have an excitation system model.

In the exemplary embodiment, the user will be notified if any prohibited model or missing excitation model has been identified. Based on this information, the user can further correct the dynamic model 306 if there is human error, or to use the model conversion module to convert any prohibited model to the valid models before evaluating the curve fitting performance. Of course, the user can also ignore the warning and continue the model validation and calibration process.

The second step is the parameter identifiability. The goal of this step is to perform a comprehensive identifiability study across the models 302 and 306, the definitions 304, and the events 308 and provide an identifiable parameter set for the simultaneous calibration which tunes the most identifiable parameters. The parameter identifiability component 312 analyzes the parameters to identify potential parameters for use based on the dot product (or scalar product) of the columns of J and r as defined below. In the exemplary embodiment, r is called residual which is the difference between the measured response data series and the simulated response data series where:

r(p)=yₜ^{m}−yₜ(x) EQ. 1

where yₜ^{m} is the measured response of active and reactive power provided in the event data 308, yₜ(x) is the simulated response of active and reactive power based on dynamic simulation engine, including but not limited to, GE's PSLF, Siemens PTI's PSS/E, etc. x represents the model parameters.

The parameter identifiability component 312 uses the sum of squares (SOS) objective: ∥r(x)∥₂². Then the parameter identifiability component 312 uses the Quadratic Model (QM) of the objective at (xₖ+d) to approximate the next step like r(xₖ₊₁).

QM(Kₖ,rₖ,d)=∥r(x)+Jₖd∥₂² EQ. 2

where Jₖ is the Jacobian vector, which is equal to

$${J}_{k} = \frac{dr}{dx} \vert xk , and {r}_{k} = r ( {x}_{k} )$$

which is the sensitivity result. This leads to:

r(xₖ₊₁)=r(xₖ)+Jₖ(xₖ+d) EQ. 3

The ultimate goal is to get r(xₖ₊₁)=0. This leads to r(xₖ)=−Jₖ(xₖ+d).

In the exemplary embodiment, the vector r(xₖ) is compared to the Jacobian vector Jₖ to determine the θ (angle) between them. In some embodiments, each vector Jₖ may have up to 1000 values each, where the number of values in the Jacobian vector depends on the number of sampling points in the event. The θ is calculated by generating the dot product of the vector r(xₖ) to the Jacobian vector Jₖ.

r(xₖ)*Jₖ=∥r(xₖ)∥|Jₖ∥cos θ EQ. 4

The resulting θ is compared to a threshold. Parameters with a corresponding θ below the threshold are sent to the pool of parameters that are selected. The ideal θ is zero, but that is generally unachievable. In some embodiments, any parameter with a θ of less than 5° is selected by the parameter identifiability component 312. This threshold is configurable by the user, such as through an interactive user interface. The key idea is that the more orthogonal the angles are between the vectors of J and r, the less likely changes to that parameter moves the response in the desired way. This approach can be extended to a weighted version, by scaling both the measured response and simulated response with a weight vector wₜ. The weight factor wₜ has the same length of the data samples in the event of interest. In this way, given a defined weight factor, it can affect the above calculated angles are between the vectors of J and r. Where r and Jₖ may be calculated as:

$$\begin{matrix}r ( {x}_{k} ) = {\sum }_{t = 1}^{T} {w}_{p} ( t ) * {( \frac{{y}_{p}^{m} ( t ) - {y}_{p} ( x , t )}{{y}_{p}^{b a s e}} )}^{2} + {w}_{q} ( t ) * {( \frac{{y}_{q}^{m} ( t ) - {y}_{q} ( x , t )}{{y}_{q}^{b a s e}} )}^{2} & EQ . 5 \\ {J}_{k} = \frac{r ( {x}_{k} + Δx ) - r ( {x}_{k} )}{Δ x} & EQ . 6\end{matrix}$$

where t represents each point of time in the event, where T is the event time length, and where wₚ(t) is a weight vector assigned along the time axis to the active power p, w_{q}(t) is a weight vector assigned along the time axis to the reactive power q, yₚ^{m}(t) represents the measured active power at time stamp t, yₚ(x, t) represents the simulation result at time stamp t with parameter x, yₚ^{base} represents the base value of the active power p.

In the exemplary embodiment, the parameter identifiability component 312 receives a plurality of raw parameters x. The parameter identifiability component 312 analyses each of the parameters using the above equations to determine the θ between the Jₖ and the r(xₖ) for each of the parameters. If the θ meets or is below a predetermined threshold, the parameter identifiability component 312 stores that parameter in a pool of parameters. In the exemplary embodiment, the parameter identifiability component 312 presents the parameters in the pool to the user for approval or adjustment via the interactive user interface 545.

Once selected or confirmed by the user, the tunable parameters are provided to the tunable parameter estimation component 314. The tunable parameter estimation component 312 adjusts the models based on the tunable parameters selected or confirmed by the user. The parameter estimation component 314 also performs weighted non-linear least squares optimizations for estimating the parameters. The goal is to identify the right parameter to minimize the difference between the yₜ(x) and yₜ^{m} so that the estimation matches the measured response.

$${min}_{{x}_{1} \leq x \leq {x}_{u}} {\sum }_{t = 1}^{T} {w}_{p} ( t ) * {( \frac{{y}_{p}^{m} ( t ) - {y}_{p} ( x , t )}{{y}_{p}^{b a s e}} )}^{2} + {w}_{q} ( t ) * {( \frac{{y}_{q}^{m} ( t ) - {y}_{q} ( x , t )}{{y}_{q}^{b a s e}} )}^{2} \qquad EQ . 7$$

where t represents each point of time in the event, where T is the event time length, and where wₚ(t) is a weight vector assigned along the time axis to the active power p, w_{q}(t) is a weight vector assigned along the time axis to the reactive power q, yₚ^{m}(t) represents the measured active power at time stamp t, yₚ(x, t) represents the simulation result at time stamp t with parameter x, yₚ^{base} represents the base value of the active power p, which could be 100 MVA for example. x₁, xᵤ represents the low bound and high bound for parameter x.

In the reality, there are around 60˜120 parameters for one typical generator simulation model. Tuning all of them given one event is not realistic and not desirable. The industry expects as few as possible on the parameter tuned given one event or multiple events. One approach is to use the above mentioned sensitivity analysis (or parameter identification) to down select only those parameter subset which lead to high sensitive response change. An alternative approach is to use the sparse optimization by adding a L1 norm as a regularization term in the objective function, and the optimization solver will determine the parameter value while minimizing the number of parameters tuned.

$${min}_{{x}_{1} \leq x \leq {x}_{u}} {\sum }_{t = 1}^{T} {w}_{p} ( t ) * {( \frac{{y}_{p}^{m} ( t ) - {y}_{p} ( x , t )}{{y}_{p}^{b a s e}} )}^{2} + {w}_{q} ( t ) * {( \frac{{y}_{q}^{m} ( t ) - {y}_{q} ( x , t )}{{y}_{q}^{b a s e}} )}^{2} + α \cdot \vert \vert x - {x}_{0} \vert {\vert}_{1} \qquad EQ . 8$$

where α is how important the tunable parameter is, x₀ is the initial parameter, x is the parameter, and ∥x−x₀∥ is a penalty term. This is considered weighted sparse nonlinear least square optimization.

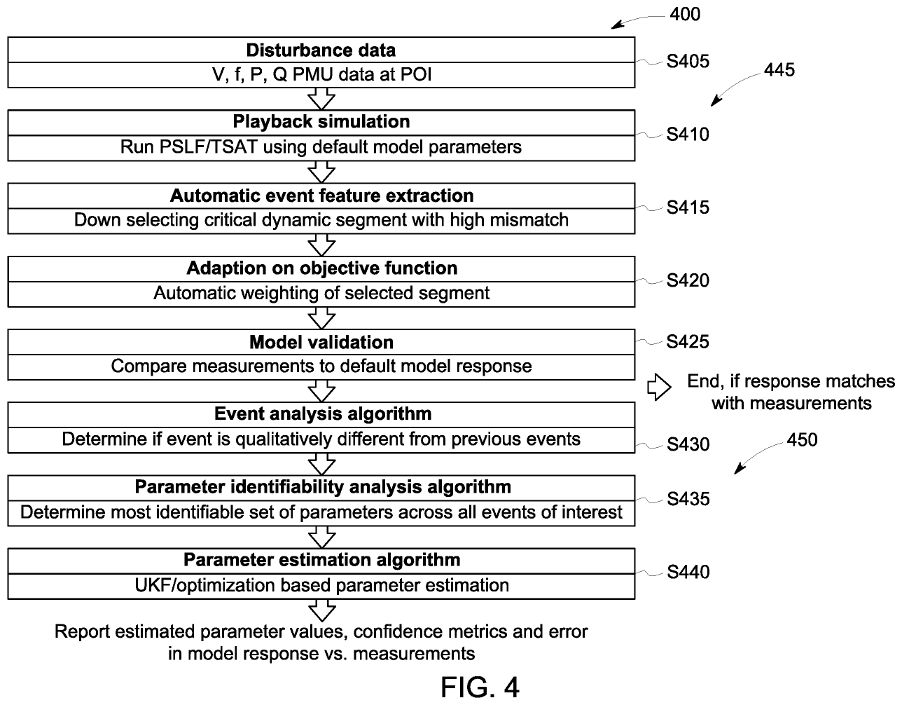

In the exemplary embodiment, the system defines regions or segments (which are portions or time slices of the event) and their corresponding weights (as shown in FIG. 4). The system also allows the user to adjust the regions and weights through the user interface. The user may then assign different weights to each region. For example, a user may assign a first weight for times 0 to 0.3 seconds in the event and a second weight for times 0.3 to 1 second into the event. In addition, the user may define two different weights for the active power curve and the reactive power curve. In some embodiments, the system defines a default weight that is used for sections or regions that do not have user defined weights.

In the exemplary embodiment, the parameter estimation component 314 performs multiple iterations of the calculations until the residual error between the measure values and the estimated values is reduced to below a threshold.

In some embodiments, the user accesses a user interface to set the total number of events 308 that will be analyzed, set the stored file locations, and set the sequence that the events 308 will be analyzed in. The user interface may also be used for other adjustments as described herein.

The feature of an event may comprise peak value, bottom value, overshoot percentage, a rising time, a settling time, delay time, peak time, steady state error, a phase shift, a damping ratio, an energy function, and a cumulative deviation in energy, Fourier transformation spectrum information, frequency response, principal component, minimum volume ellipsoid, steady state gain (P, Q, u, f), of the event. The feature is extracted from the time series of active power, reactive power, voltage and frequency.

FIG. 4 is a process 400 for power system model parameter conditioning according to some embodiments. At Step 405, disturbance data may be obtained (e.g., from a PMU or DFR) to obtain, for example, V, f, P, and Q measurement data at a Point Of Interest (“POI”). At Step 410, a playback simulation may run load model benchmarking using default model parameters (e.g., associated with a Positive Sequence Load Flow (“PSLF”) or Transient Security Assessment Tool (“TSAT”)). At Step 415, automatic event feature extraction analyzes events to select critical dynamic segments or regions with significant amounts of mismatch between the simulated responses and the actual measure values. At Step 420, adaption on objective function provides automatic weighting on the segments selected in Step 415. At Step 425, model validation may compare measurements to default model response. If the response matches the measurements, the framework may end (e.g., the existing model is sufficiently correct and does not need to be updated). At Step 430, an event analysis algorithm may determine if event is qualitatively different from previous events. At Step 435, a parameter identifiability analysis algorithm may determine most identifiable set of parameters across all events of interest. For example, a first event may have 90 to 100 parameters. For that event, Step 435 uses the parameter identifiability algorithm to select 1 to 20 of those parameters. In some embodiments, the parameter identifiability algorithm uses the identified segments and their corresponding weights for its calculations.

Finally, at Step 440 an Unscented Kalman Filter (“UKF”)/optimization-based parameter estimation algorithm/process may be performed. As a result, the estimated parameter values, confidence metrics, and error in model response (as compared to measurements) may be reported. In some embodiments, the parameter estimation algorithm uses the identified segments and their corresponding weights for its calculations. In some embodiments, Steps 405-425 are considered model validation 445 and Steps 430-440 are considered model calibration 450. As described elsewhere herein, the systems may use one or both of model validation 445 and model calibration 450. In some embodiments, Steps 405-440 are considered a model validation and calibration (MVC) process 400.

Disturbance data may be monitored by one or more PMUs coupled to an electrical power distribution grid may be received. The disturbance data can include voltage (“V”), frequency (“f”), and/or active and reactive (“P” and “Q”) power measurements from one or more points of interest (POI) on the electrical power grid. A power system model may include model parameters. These model parameters can be the current parameters incorporated in the power system model. The current parameters can be stored in a model parameter record. Model calibration involves identifying a subset of parameters that can be “tuned” and modifying/adjusting the parameters such that the power system model behaves identically or almost identically to the actual power component being represented by the power system model.

In accordance with some embodiments, the model calibration can implement model calibration with three functionalities. The first functionality is an event screening tool to select characteristics of a disturbance event from a library of recorded event data. This functionality can simulate the power system responses when the power system is subjected to different disturbances. The second functionality is a parameter identifiability study. When implementing this functionality, the can simulate the response(s) of a power system model. The third functionality is simultaneous tuning of models using event data to adjust the identified model parameters. According to various embodiments, the second functionality (parameter identifiability) and the third functionality (tuning of model parameters) may be done using a surrogate model in place of a dynamic simulation engine 316.

Here, the model calibration algorithm attempts to find a parameter value (θ*) for a parameter (or parameters) of the power system model that creates a matching output between the simulated active power (\hat{P}) and the simulated reactive power (\hat{Q}) predicted by the model with respect to the actual active power (P) and actual reactive power (Q) of the component on the electrical grid.

As grid disturbances occur intermittently, the user of the calibration tool described herein may be required to re-calibrate model parameters in a sequential manner as new disturbances come in. In this scenario, the user has a model that was calibrated to some observed grid disturbances to start with, and observes a larger that acceptable mismatch with a newly encountered disturbance. The task now is to tweak the model parameters so that the model explains the new disturbance without detrimentally affecting the match with earlier disturbances. One solution would be to run calibration simultaneously on all events of interest strung together but this comes at the cost of significant computational expense and engineering involved in enabling running a batch of events simultaneously. It would be far more preferable to carry some essential information from the earlier calibrations runs and guide the subsequent calibration run that helps explain the new disturbance without losing earlier calibration matches.

In the exemplary embodiment, the framework of Bayesian estimation may be used to develop a sequential estimation capability into the existing calibration framework. The true posterior distribution of parameters (assuming Gaussian priors) after the calibration process can be quite complicated due to the nonlinearity of the models. The typical approach in sequential estimation is to consider a Gaussian approximation of this posterior as is done in Kalman filtering approaches to sequential nonlinear estimation. In our nonlinear least squares approach, this boils down to a quadratic penalty term for deviations from the previous estimates, and the weights for this quadratic penalty come from a Bayesian argument.

Event screening can be implemented during the simulation to provide computational efficiency. If hundreds of events are stitched together and fed into the calibration algorithm unselectively, the algorithm may not be able to converge. To maintain the number of events manageable and still keep an acceptable representation of all the events, a screening procedure may be performed to select the most characteristic events among all. Depending on the type of events, the measurement data could have different characteristics. For example, if an event is a local oscillation, the oscillation frequency in the measurement data would be much faster as compared to an inter-area oscillation event. In some implementations, a K-medoids clustering algorithm can be utilized to group events with similar characteristic together, thus reducing the number of events to be calibrated.

Instead of using the time-consuming simulation engine, the surrogate model or models (such as Neural Networks) with equivalent function of dynamic simulation engine, may be used for both identifiability and calibration. The surrogate model may be built offline while there is no request for model calibration. Once built, the surrogate model comprising a set of weights and bias in learned structure of network will be used to predict the active power (\hat{P}) and reactive (\hat{Q}) given different set of parameters together with time stamped voltage (V) and frequency (f).

The parameter identifiability analysis addresses two aspects: (a) magnitude of sensitivity of output to parameter change; and (b) dependencies among different parameter sensitivities. For example, if the sensitivity magnitude of a particular parameter is low, the parameter would appear in a row being close to zero in the parameter estimation problem's Jacobian matrix. Also, if some of the parameter sensitivities have dependencies, it reflects that there is a linear dependence among the corresponding rows of the Jacobian. Both these scenarios lead to singularity of the Jacobian matrix, making the estimation problem infeasible. Therefore, it may be important to select a subset of parameters which are highly sensitive as well as result in no dependencies among parameter sensitivities. Once the subset of parameters is identified, values in the active power system model for the parameters may be updated, and the system may generate a report and/or display of the estimated parameter values(s), confidence metrics, and the model error response as compared to measured data.

In the exemplary embodiment, process 400 is performed serially, where a first event and a first set of parameters values are used inputs into process 400. Once the model calibration stage 450 of process 400 is complete, then the system receives adjusted values for those parameters based on the analysis of the first event. Then the system starts process 400 over with a second event and the adjusted values for those parameters. In the exemplary embodiment, the system continues to execute process 400 using adjusted parameters from the previous execution of process 400 and a new event. In some embodiments, this process continues until the simulated response matches the measured values for the actual event.

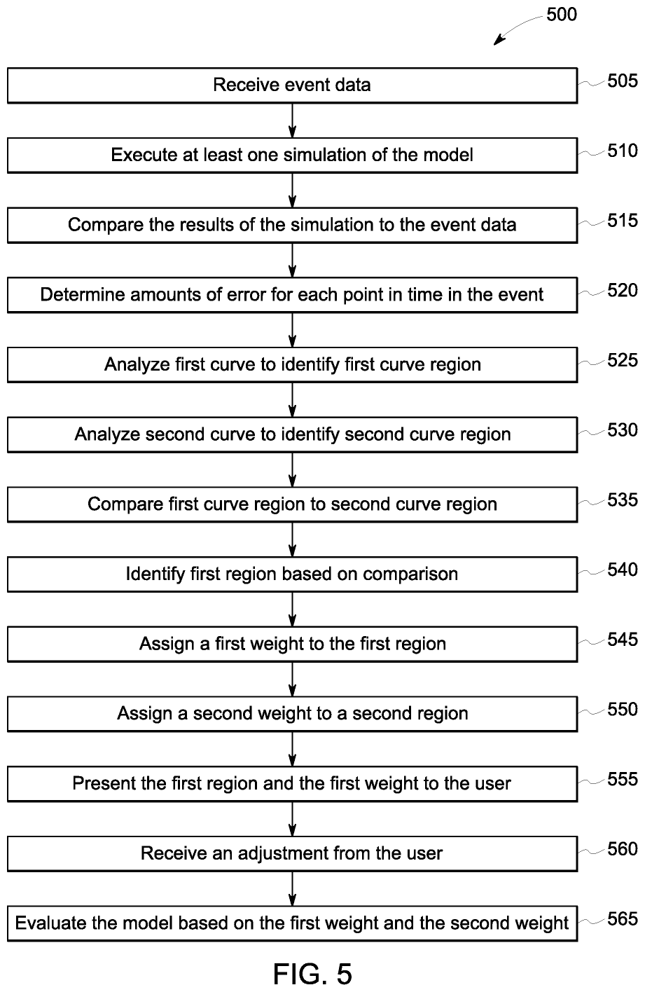

FIG. 5 illustrates a process 500 for enhanced power system model calibration, in accordance with at least one embodiment. In some embodiments, the process 500 is performed by the system architecture 300 (shown in FIG. 3).

In process 500, the system 300 receives 504 event data 308 and model response data 304 associated with a model 302 and 306 (all shown in FIG. 3) to simulate. In some embodiments, step 505 is similar to Step 405 (shown in FIG. 4). The system 300 executes 510 at least one simulation of the model. In some embodiments, the simulation of the model is performed by the simulation engine 316 (shown in FIG. 3). In some embodiments, step 510 is similar to Step 410. In the exemplary embodiment, the simulation engine 316 executes a simulation of the event 308 using the same input data and applies the input data to the model and parameters. In the exemplary embodiment, the event data 308 includes at least two curves an active power curve and a reactive power curve. In other embodiments, the event data 308 may include other curves, such as, but not limited to, voltage and frequency.

In the exemplary embodiment, the system 300 compares 515 the results of the simulation to the event data 308. The system 300 determines 520 an amount of error for each point of time in the event data. More specifically, for each point in time, the system 300 determines 520 the difference between the measured curve(s) and the simulated curve(s) to calculate the error, such as by using means squared error.

In embodiments where the event data includes two curves, the system 300 analyzes 525 the first curve (active power) to identify a first curve region. The system 300 analyzes 530 the second curve (reactive power) to identify a second curve region. The system 300 compares 535 the first curve region to the second curve region. The system 300 uses the comparison to determine 540 a first region to analyze. In some embodiments, the system 300 determines where there is an overlap between the two regions to determine the first region.

In the exemplary embodiment, the system 300 assigns 545 a first weight to the first region. In some embodiments, the system 300 determines the first weight based on the error for that region. In some further embodiments, the system 300 determines different weights for different portions of the first region. The system 300 also assigns 550 a second weight to a second region. This second region may be a portion of the first region. The second region may also be outside of the first region. For example, the second region may be a steady state area of the event and the system 300 assigns 550 that area a low weight relative to those assigned 545 to the first region. That way the second region affects the calibration and evaluation of the model less than the first region.

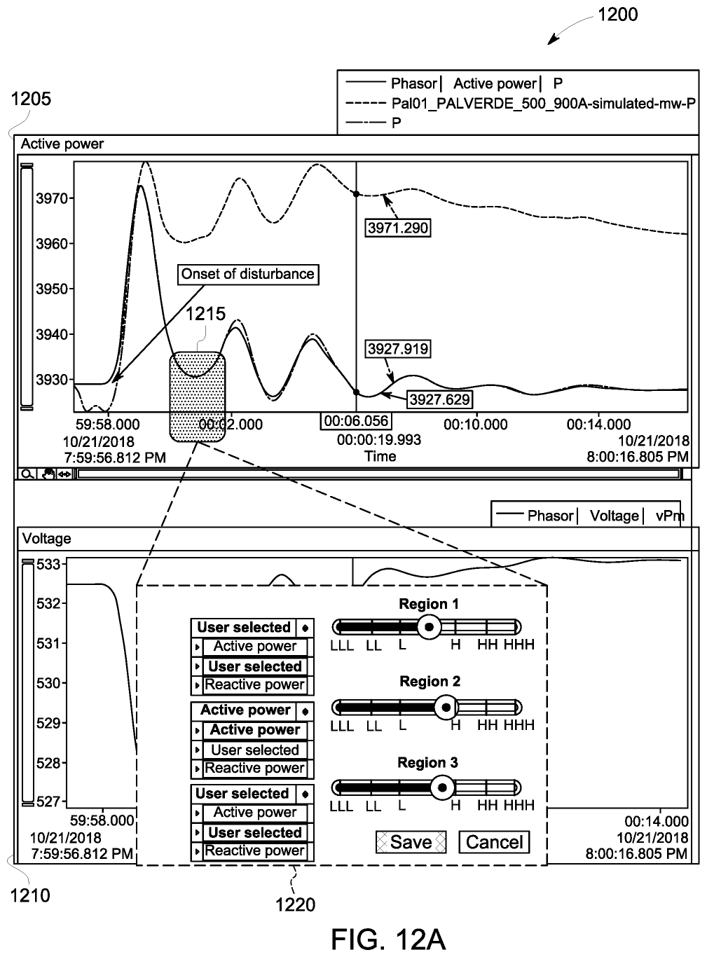

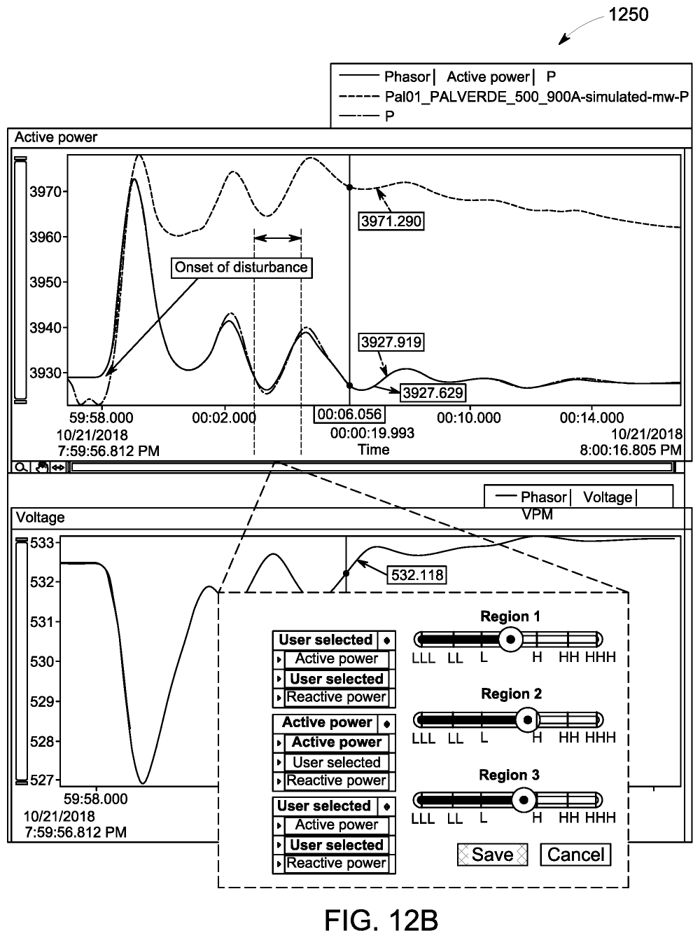

In some embodiments, the system 300 presents 555 the first region and the first weight to the user, such as through the user interface 1200 or 1250 (shown in FIGS. 12A and 12B). The system 300 may receive 560 an adjustment to the region and/or the weights from the user.

The system 300 evaluates 565 the model based on the first weight and the second weight. Evaluating 565 the model may include, but is not limited to, model validation, model parameter screening, model parameter estimation, automatically determining which region to present in the user interface, and any combination of the aforementioned actions.

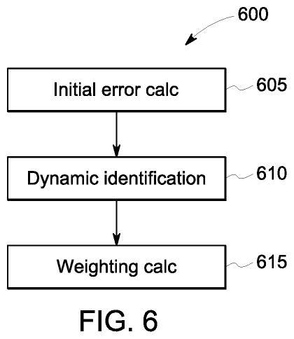

FIG. 6 illustrates a process 600 for identifying and weighting features of events, in accordance with one embodiment. In the exemplary embodiment, process 600 may occur during model validation 445 (shown in FIG. 4). In some embodiments, process 600 is performed by the dynamic behavior characterization component 318 (shown in FIG. 3).

In the exemplary embodiment, the simulation engine 316 (shown in FIG. 3) performs a simulation of a chosen event using the current parameters for the models 302 and 306 (both shown in FIG. 3). The resulting active power and reactive power curves from the simulation of the event 308 are compared to the measured values of the actual event 308. In some embodiments, this analysis is performed by calculating the error 605 between the two sets of curves. This calculation may be performed by calculating the means square error based on the difference between the actual measured curve and the simulated results.

In the exemplary embodiment, the system 300 dynamically identifies 610 the portions of the events to be further analyzed based on the error, otherwise known as those portions of the curves where the statistical properties change. For example, the system 300 may use changepoint analysis or minimum volume enclosing ellipsoid (MVEE) to extract the features.

Changepoint analysis uses an ordered sequence of data, y_{1:n}=y₁, . . . , yₙ). If an event has a number of changepoints, m, with corresponding positions, τ_{1:m}=(τ₁, . . . , τₘ), where each changepoint position is an integer between 1 and n−1 inclusive. τ₀ may be defined to equal zero and τₘ₊₁ equal to n. Furthermore, the changepoints are ordered such that τᵢ<τⱼ and i<j. Accordingly, the m changepoints split the data into m+1 segments with the ith segment containing y(τᵢ₋₁+1):τᵢ. the changepoints may be identified by minimizing:

$${\sum }_{i = 1}^{m + 1} [ C ( {y}_{( {τ}_{i - 1 + 1 ) : {τ}_{1}}} ) ] + β f ( m ) \qquad EQ . 9$$

where C is a cost function for a segment and βf(m) is a penalty to protect against overfitting.

This may be applied to the events 308 to find a signal changepoint. The system 300 chooses a point and divides the signal into two sections. Then the system 300 computes an empirical estimate of the desired statistical property for each section. At each point within a section, the system 300 measures how much the property deviates from the empirical estimate. The system 300 then adds the deviations for all points and adds the deviations section-to-section to find the total residual error. The system 300 varies the location of the division point until the total residual error attains a minimum. In the exemplary embodiment, the chosen statistic is the mean. In that case, finding changepoints minimizes the total residual error from the “best” horizontal level for each section. The statistics may also include ‘standard deviation’—detect changes in standard deviation; ‘linear’—detect changes in mean and slope; and ‘ root-mean-square’ to detect changes in root-mean-square level.

The minimum volume enclosing ellipsoid (MVEE) method uses sliding data windows. For each sliding data window P (m by n) of ‘m’ signals and ‘n’ samples, an ‘m’ dimensional ellipsoid can be obtained which contains at least all ‘n’ samples and is of minimum volume.

E(A,c)={p∈Rⁿ|(p−c)^{T}A(p−c)≤1} EQ. 10

This ellipsoid may be obtained by solving:

min[\sqrt{det A}]⁻¹s.t.(xᵢ−c)^{T}A(xᵢ−c)≤1,i=1:M,A∈S_{N}⁺⁺ EQ. 11

where A=A′ is a symmetric positive definite matrix. A′ may be obtained by applying Khachiyan's method. Matrix A describes the ellipsoid properties. The shape, volume, orientation and rate of change of the ellipsoid parameters signify the change of system dynamic behavior including the disturbance start and ending, which can be utilized here to define the event data segmentation. This allows the system to detect the start and the end of the event. Furthermore, MVEE allows the system to detect features, such as, but not limited to, volume of ellipsoid, rate of change of volume, center point of ellipsoid, axis length of ellipsoid, eccentricity, and geometric mean radius.

The system may detect the start of the event from volume or rate of change of volume of the ellipsoid. In some embodiments, the ending of the event may be more prominent when analyzing the ‘Eccentricity’ feature and ‘geometric mean radius’ features. The volume of the ellipsoid at sliding window j may be calculated as:

$${Vol ( {E}_{A c} )}^{j} = {\frac{{π}^{n / 2}}{Γ ( 0.5 n + 1 )} [ \sqrt{det A} ]}^{- 1} \qquad EQ . 12$$

The semi-axis lengths of the ellipsoid at the sliding window j can be calculated after applying SVD on matrix A.

$${A}^{j} = {USV}^{T} = [ {u}_{1} {u}_{1} {… u}_{N} ] [ \begin{matrix}{λ}_{1} & 0 & 0 & 0 \\ 0 & {λ}_{2} & 0 & 0 \\ 0 & 0 & \text{...} & 0 \\ 0 & 0 & 0 & {λ}_{N}\end{matrix} ] [ \begin{matrix}{v}_{1}^{T} \\ {v}_{2}^{T} \\ … \\ {v}_{N}^{T}\end{matrix} ] \qquad EQ . 13$$

where, uᵢ, vᵢ∈ [symbol] ^{N} are the left and right singular vectors respectively. λᵢs are the singular values. After applying SVD on matrix A, the semi axes lengths rᵢ can be obtained as:

rᵢ^{j}=1/\sqrt{λᵢ} EQ. 14

where rₘₐₓ and rₘᵢₙ are the major and minor semi-axes lengths, respectively.

The eccentricity of the ellipsoid at the sliding window j may be obtained as

e^{j}=\sqrt{(rₘₐₓ²−rₘᵢₙ²)}/rₘₐₓ EQ. 15

The geometric mean radius (GMR) describes the size of the ellipsoid for sliding window j.

g^{j}=(Πᵢ₌₁^{N}rᵢ)^{1/n} EQ. 16

While detecting the features using changepoint and MVEE is described herein, other methods of statistical change detection may be used to detect features in accordance with the methods described herein.

For each feature detected, the system 300 calculates weights 615 for the individual features. This may be done by generating a weight vector for the active power curve and the inactive power curve each event or detected feature. In some embodiments, the system 300 only calculates weights 615 for the selected features. In other embodiments, the system 300 calculates weights 615 for the entire event. Using a non-weighted non-least squares approach, wp and wq are identity vectors where every element is 1. In some embodiments, each element in the vector may correspond to one data sample in the corresponding P or Q curve. In other embodiments, each element in the vector may correspond to a block of multiple data samples in the corresponding P or Q curve. The identity vectors wp and wq are shown below in TABLE 2.

TABLE 2

| | | | | | | |
|---|---|---|---|---|---|---|
| wp | 1 | 1 | 1 | 1 | 1 | 1 |
| wq | 1 | 1 | 1 | 1 | 1 | 1 |

The relative importance of P and Q in the optimization can be adjusted by set a scaling factor K=wp/wq. K>1 means more emphasis is exerted on P than Q, and vice versa. TABLE 3 below shows that wp is 10 times that of wq, which exerted more importance on P curve than Q curve.

TABLE 3

| | | | | | | |
|---|---|---|---|---|---|---|
| wp | 10 | 10 | 10 | 10 | 10 | 10 |
| wq | 1 | 1 | 1 | 1 | 1 | 1 |

The relative importance inside either P curve or Q curve may be assigned. For example, if a region in P curve with significant dynamic information is identified, then the weight in that region can be increased so that the curve fitting deviation in that region will lead to more penalty to the objective function value, and hence, more importance in the NLS optimization process. The example below in TABLE 4 shows that the data samples/blocks 2 and 3 has more importance than other data samples for both P curve and Q curve.

TABLE 4

| | | | | | | |
|---|---|---|---|---|---|---|
| wp | 1 | 1 | 2 | 2 | 1 | 1 |
| wq | 1 | 1 | 2 | 2 | 1 | 1 |

Table 5 below example shows data samples 3 and 4 have more importance than others inside P curve, while data samples 4 and 5 in Q curve have more importance. The importance level can be determined based on its abundance of dynamic information.

TABLE 5

| | | | | | | |
|---|---|---|---|---|---|---|
| wp | 1 | 1 | 2 | 2 | 1 | 1 |
| wq | 1 | 1 | 1 | 2 | 2 | 1 |

In some embodiments, the weighting is based on the relative error for each curve. For example, if the error for the P curve was 10 times greater than the error for the Q curve, then the system 300 may set the weights for the P curve to be 10 times that of the weights on the Q curve. Furthermore, this relationship may be proportional or based on another equation as needed.

These points in time are used with their corresponding weights in the parameter estimation algorithm 440 (shown in FIG. 4) as described above. Furthermore, the matrices of weights may be used with the Jacobian calculations Jₖ and residual r described above in EQs. 7 and 8. If the weighting matrix changes, then the parameter selection results would change accordingly.

In some embodiments, the wq and wp vectors include all of the data points in the event and the system adjusts the weights of those data points that are a part of the desired data segment or the extracted features. In other embodiments, the system trims off the data points that are outside of the desired data segment.

While the above process 600 is described based on the active and reactive power curves, other variables, such as voltage and/or frequency may be used for feature identification, extraction, and weighting. These may be used in combination with or separately from the other variables.

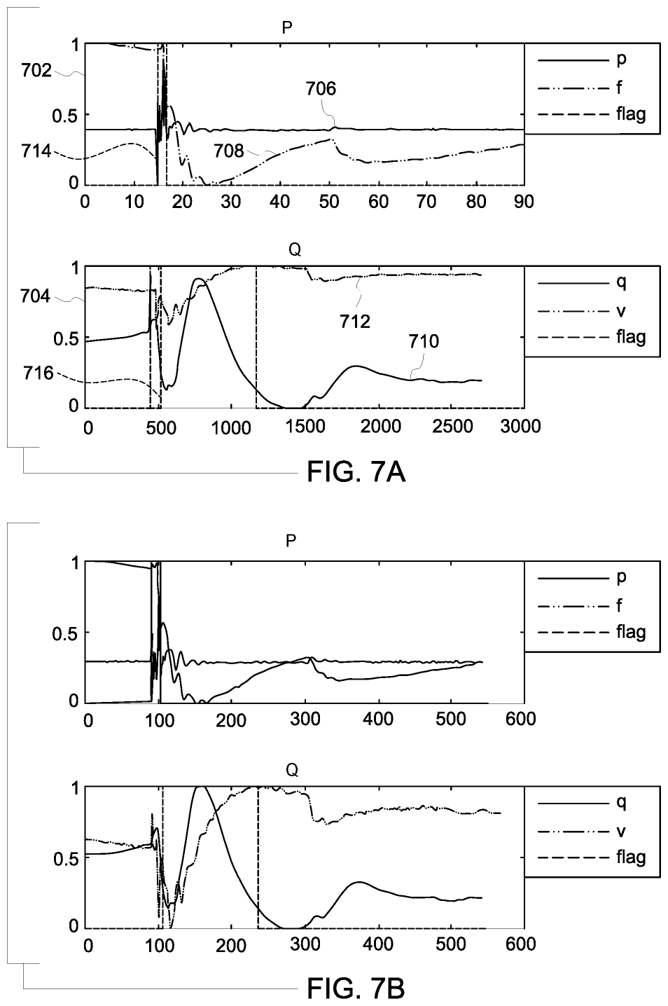

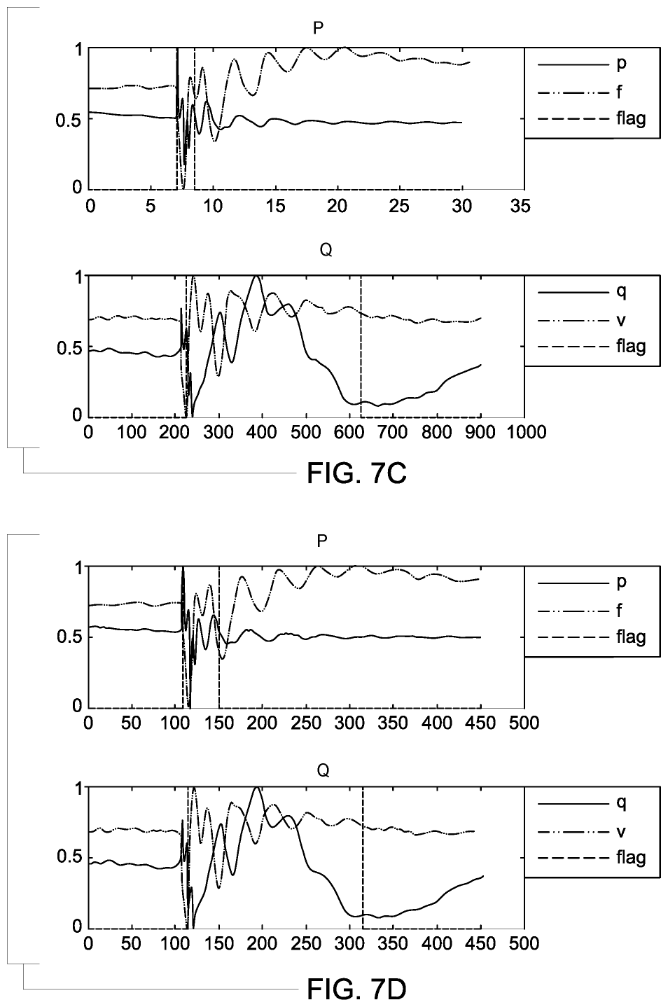

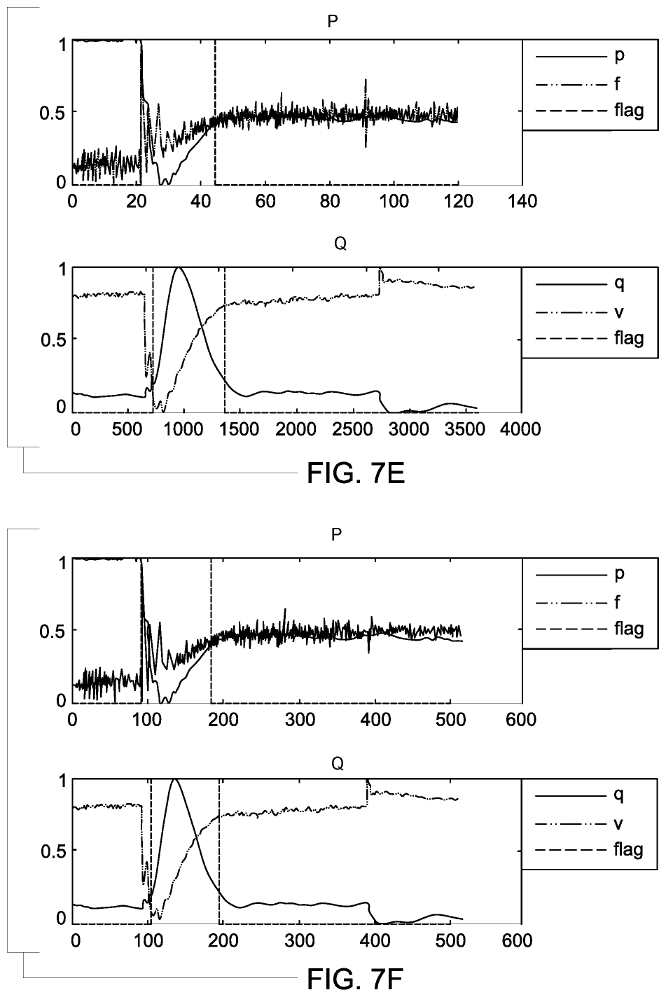

FIGS. 7A-7F illustrate a plurality of graphs of events with highlighted features in accordance with at least one embodiment. In FIGS. 7A-7F, there is a graph 702 of active power p in relation to time t(s) and a graph 704 of reactive power q broken down by points, where 30 points equal 1 second. Active power graph 702 includes the active power 706 of an event and the frequency 708 of the event. Reactive power graph 704 includes the reactive power 710 of the event and the voltage 712 of the event.

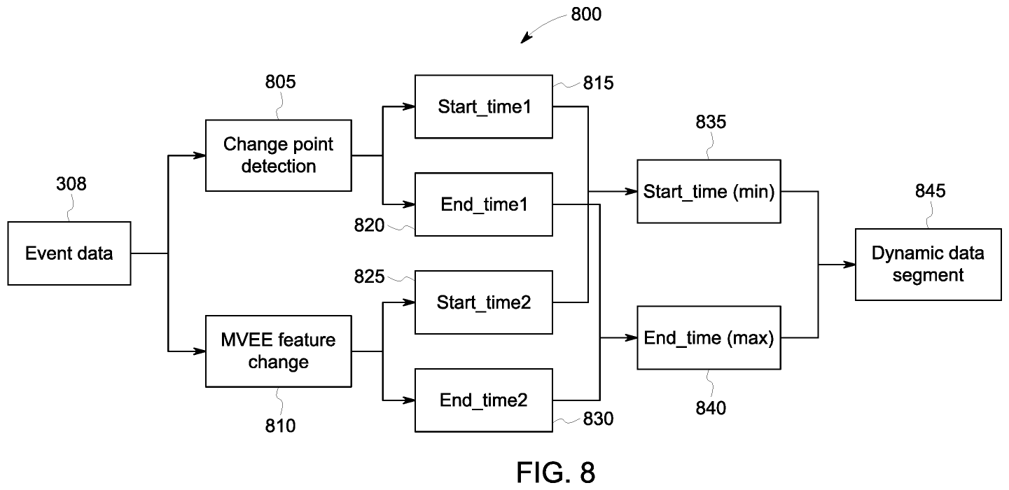

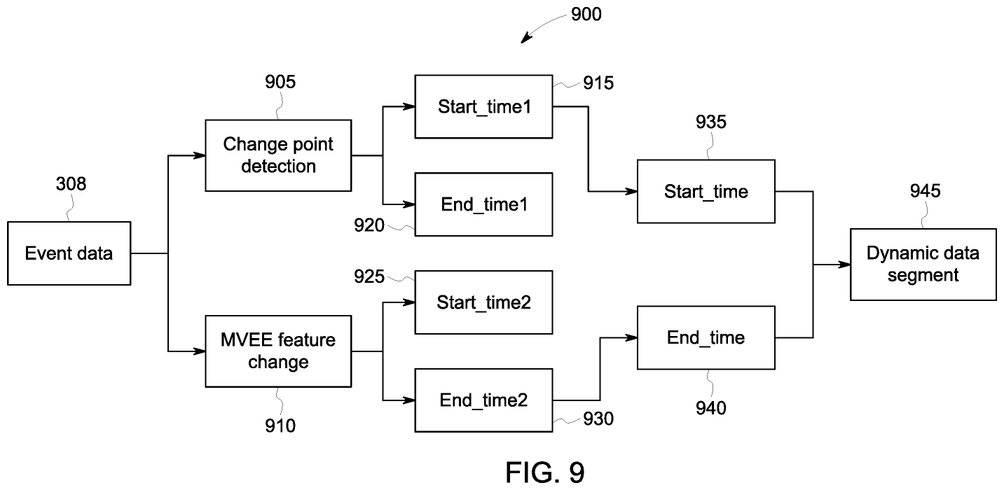

FIGS. 7A-7F also illustrate a flagged section 714 and 716 of the event for the active power graph 702 and the reactive power graph 704, respectively. In the exemplary embodiment, each flagged section 714 and 716 is calculated using one or more of process 600 (shown in FIG. 6), process 800 (shown in FIG. 8), and process 900 (shown in FIG. 9). In the exemplary embodiment, the system analyzes the active power curve 706 and/or the frequency 708 to determine the start and the end of the corresponding flagged section 714. The system also analyzes the reactive power curve 710 and the voltage 712 to determine the start and the end of flagged section 716.

In the exemplary embodiment, the system combines flagged sections 714 and 716 to determine the desired data segment. As shown in FIGS. 7A-7F, the flagged section 714 associated with the top graph 702 does not completely match with the flagged section 716 associated with the bottom graph 704. In these embodiments, the two flagged sections 714 and 716 will be combined into one section. If the two flagged sections 714 and 716 don't overlap, then the system may have the desired data segment start at the beginning of the earliest segment and continue through the end of the later segment. In another embodiment, the system may determine two data segments, one for each flagged section.

In the exemplary embodiment, FIGS. 7B, 7D, and 7F are down sampled versions of FIGS. 7A, 7C, and 7E, respectively. This means that the graphs in FIGS. 7B, 7D, and 7F are generated using significantly less data points than the graphs of 7A, 7C, and 7E. For example, FIGS. 7A, 7C, and 7E may have been generated with 1000 data points each and FIGS. 7B, 7D, and 7F may have been generated with 100 data points each.

In some embodiments, the desired data segment is displayed to the user via a user interface. In these embodiments, the user may use the user interface to adjust the start and endpoints of the desired data segments. The user may also adjust the weights.

FIG. 8 illustrates a process 800 for detecting a dynamic data segment 845 of an event for analysis in accordance with at least one embodiment. In the exemplary embodiment, process 800 may occur during model validation 445 (shown in FIG. 4). In some embodiments, process 800 is performed by the dynamic behavior characterization component 318 (shown in FIG. 3).

In the exemplary embodiment, event data 308 is received. The event data 308 may include, but is not limited to, voltage, frequency, active power, reactive power, and any combination thereof. The system feeds the data from an event 308 into a changepoint detection module 805 and a MVEE feature change module 810. The changepoint detection module 805 determines a start time 815 and end time 820 for the feature. The MVEE feature change detection module 810 also determines a start time 825 and end time 830 for the feature. The system determines the earliest start time 835 from start time 815 and start time 825. The system also determines the latest end time 840 from end time 820 and end time 830. The system uses the earliest start time 835 and the latest end time 840 to define the dynamic data segment 845.

In the exemplary embodiment, process 800 is performed for a plurality of events 308, where each event is fed serially into process 400 (shown in FIG. 4).

FIG. 9 illustrates another process 900 for detecting a dynamic data segment of an event for analysis in accordance with at least one embodiment. In the exemplary embodiment, process 900 may occur during model validation 445 (shown in FIG. 4). In some embodiments, process 900 is performed by the dynamic behavior characterization component 318 (shown in FIG. 3).

In the exemplary embodiment, event data 308 is received. The event data 308 may include, but is not limited to, voltage, frequency, active power, reactive power, and any combination thereof. The system feeds the data from an event 308 into a changepoint detection module 905 and a MVEE feature change module 910. The changepoint detection module 905 determines a start time 915 and end time 920 for the feature. The MVEE feature change detection module 910 also determines a start time 925 and end time 930 for the feature.

In some embodiments, the changepoint detection module 905 is more accurate in detecting the beginning of a sudden change and voltage. In these embodiments, the MVEE feature change detection module 910 uses the ‘eccentricity’ feature and the ‘geometric mean radius’ features to detect the end of the feature. Accordingly, the system discards the end time 920 from the changepoint detection module 905 and the start time 925 from the MVEE feature change detection module 910. The system uses the start time 915 from the changepoint detection module 905 as the earliest start time 935 from start time 815 and the end time 930 from the MVEE feature change detection module 910 as the latest end time 940. The system uses the earliest start time 935 and the latest end time 940 to define the dynamic data segment 945.

In the exemplary embodiment, process 900 is performed for a plurality of events 308, where each event is fed serially into process 400 (shown in FIG. 4).

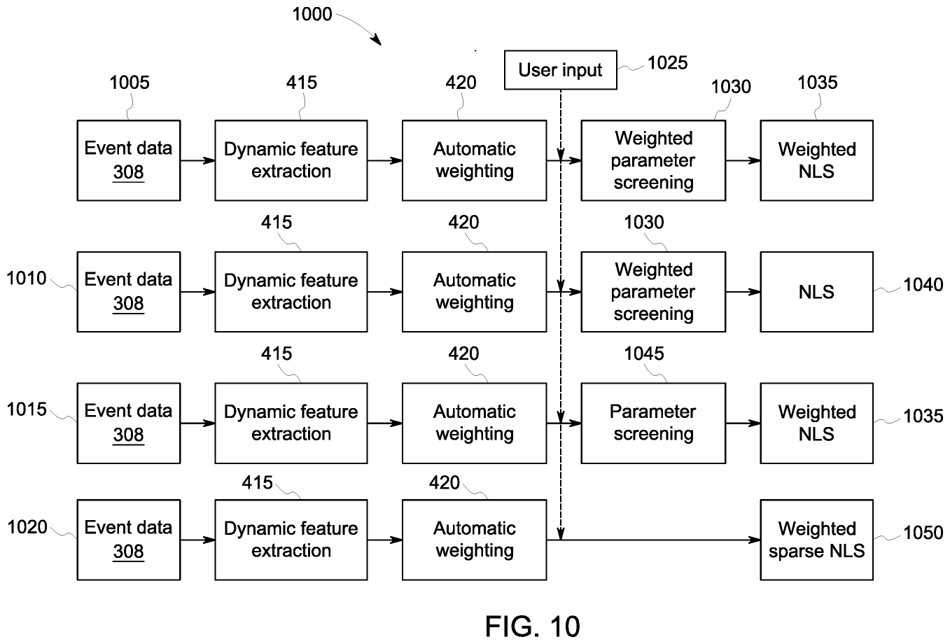

FIG. 10 illustrates a plurality of processes for identifying and estimating parameters using variations of the process 600 (shown in FIG. 6). In the exemplary embodiment, processes 1005-1020 are different methods of performing the processes 400 (shown in FIG. 4) and 600 described herein.

In processes 1005-1020, event data 308 is used for dynamic feature extraction 415 and automatic weighting 420 of the extracted features. Then the features and their corresponding weights are present to a user for user input 1025. For example, the user may adjust the features, weights, and/or parameters as described herein.

In process 1005, the system performs weighted parameter screening 1030 on the features, weights, and parameters, such as shown in Equations 5 and 6. Then the system performs the weighted non-linear least squares optimization 1035 shown in Equation 7. In this embodiment, the dynamic feature extraction from the events affects both the parameter screening and the parameter estimation.

In process 1010, the system performs weighted parameter screening 1030 on the features, weights, and parameters, such as shown in Equations 5 and 6. Then the system performs the non-linear least squares optimization 1040 without the weights. In this embodiment, the dynamic feature extraction from the events affects the parameter screening only. In process 1015, the system performs parameter screening 1045 where all of the weights are equal to 1. Then the system performs the weighted non-linear least squares optimization 1035 shown in Equation 7, wherein the weights are determined by the dynamic feature extraction. In this embodiment, the dynamic feature extraction from the events affects the parameter estimation only.

In process 1020, the system performs weighted spares non-linear least squares optimization 1050 shown in Equation 8, wherein the weights are determined by the dynamic feature extraction. In this embodiment, the dynamic feature extraction from the events affects the parameter estimation only. Compared to the process 1015, process 1020 does not have an explicit parameter screening/selection process. Instead, Process 1020 implicitly screen the model parameter during the parameter estimation procedure by using the weighted sparse Nonlinear Least Square method as shown in Equation 8.

In some embodiments, the user may select which process 1005-1020 to use. In other embodiments, the system may select which process 1005-1020 to use. In still further embodiments, the system may perform all of processes 1005-1020 in parallel and then aggregate the results.

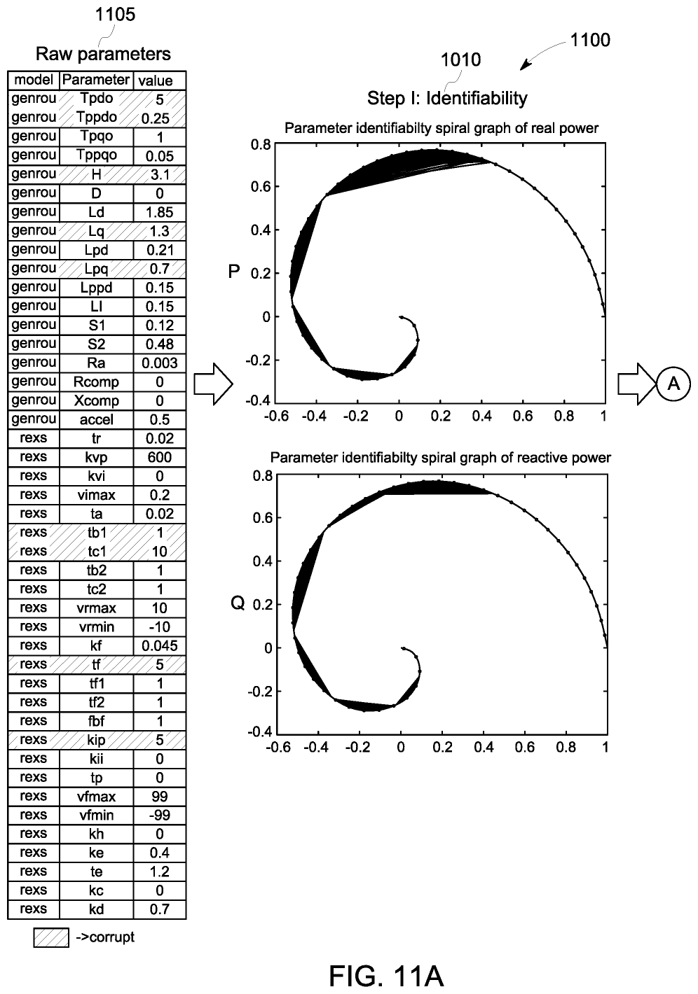

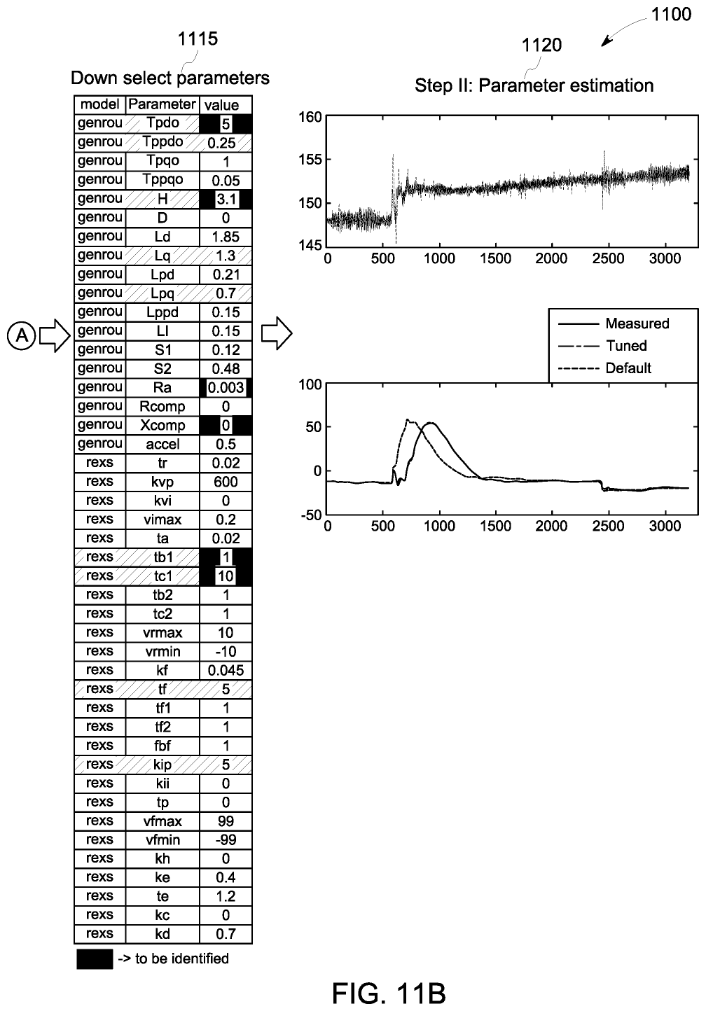

FIGS. 11A and 11B illustrate a process 1100 for identifying and estimating parameters in accordance with at least one embodiment. In process 1100, the raw parameters 1105 are analyzed to be identified 1110. Some of the parameters are then down selected 1115. In the exemplary embodiment, these are parameters that have been selected 1115 by the system 300 (shown in FIG. 3). In the exemplary embodiment, these selected parameters are presented to the user, such as through an interactive user interface. The user may confirm these parameters, change them, adjust them, and/or override them. Once the user has chosen which parameters are to be evaluated, the system 300 performs parameter estimation 1120.

FIGS. 12A and 12B illustrate exemplary user interfaces 1200 and 1250 for adjusting a region and its corresponding weights for calibration in accordance with at least one embodiment. In the exemplary embodiment, user interface 1200 is provided by an interactive user interface (not shown). In the exemplary embodiment, user interface 1200 displays active power 1205 and voltage 1210 for an event, showing actual and estimated curves. The user interface 1200 displays a selected region 1215 of one of the curves, such as one highlighted by flagged section 714 or 716 (shown in FIG. 7). User interface 1200 allows the user to adjust one or more attributes of the region 1215. The attributes may include, but are not limited to, start point, stopping point, and the corresponding weights. Furthermore, user interface 1200 allows the user to divide the region 1215 into sub-regions and apply different weights to the different sub-regions. The user interface 1200 may select a portion of the region 1215 by selecting two points to create a box that outlines the sub-region. When the region 1215 or sub-region is selected, the user interface 1200 displays a weighting interface 1220. The weighting interface 1220 includes a plurality of weighting sliding bars 1225 for a plurality of regions. Each of the plurality of weighting sliding bars 1225 includes a plurality of weights that the user may set with the slider.

In the exemplary embodiment, the user may set the weights for each selected region 1215 or sub-region, the entire active power curve, and the entire reactive power curve. While only three weighting sliding bars 1225 are shown, any number of regions may be selected and weighted. For example, a user may select a region at the beginning of the curve, where the curves are significantly different. The user may then weight that region highly. Then the user may select the region after the vertical line, where the curves are closer to a steady state and then give that region a very low rate.

When a region 1215 is selected, the region 1215 includes all of the points in time included in that region 1215. These points in time are used with their corresponding weights in the parameter estimation component 314 (shown in FIG. 3) or parameter estimation algorithm 440 (shown in FIG. 4) as described above.

As shown in this embodiment, the weights are relative based on the plurality of weighting sliding bars 1225. In other embodiments, the user may enter the actual weights or provide them in any other methodology that allows the system to perform as described herein.

User interface 1250 is similar to user interface 1200, except instead of selecting the regions using a box mechanism as shown in FIG. 12A, the user interface 1250 in FIG. 12B illustrates the use of two or more vertical sliding bars to define the beginning and the end of each region. By simply moving around the vertical line, the user can define the region between the adjacent lines as the highlighted region,

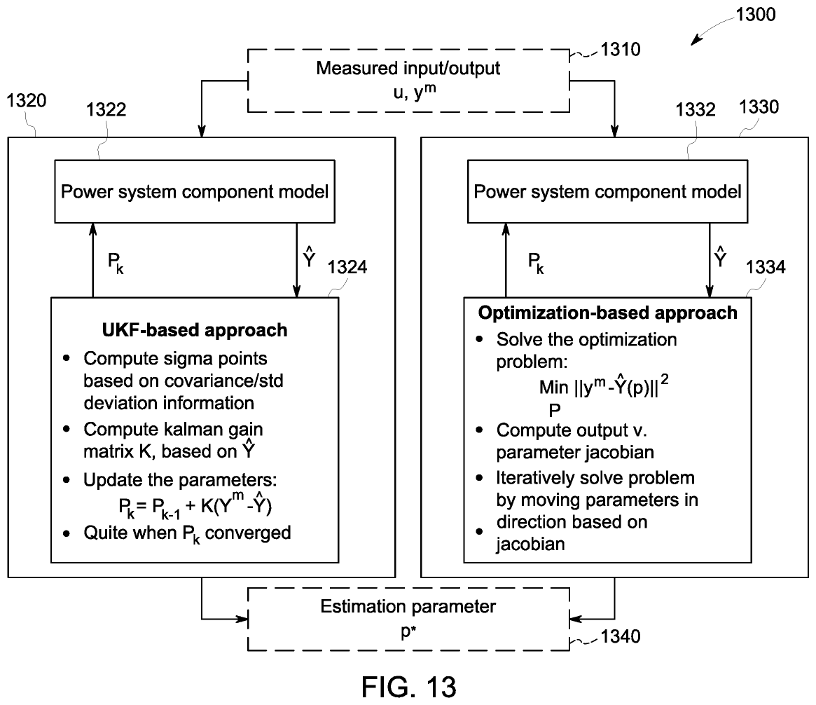

FIG. 13 illustrates candidate parameter estimation algorithms 1300 according to some embodiments. In one approach 1320, measured input/output data 1310 (u, y^{m}) may be used by a power system component model 1322 and an UKF based approach 1324 to create an estimation parameter (p*) 1340.

In particular, the system may compute sigma points based on covariance and standard deviation information. The Kalman Gain matrix K may be computed based on Ŷ and the parameters may be updated based on:

pₖ=pₖ₋₁+K(y^{m}−ŷ)

until pₖ converges. According to another approach 1330, the measured input/output data 1310 (u, y^{m}) may be used by a power system component model 1332 and an optimization-based approach 1334 to create the estimation parameter (p*) 1340. In this case, the following optimization problem may be solved:

$${min}_{p} \vert \vert {y}^{m} - \hat{Y} ( p ) {\vert \vert}^{2}$$

The system may then compute output as compared to parameter Jacobian information and iteratively solve the above optimization problem by moving parameters in directions indicated by the Jacobian information.

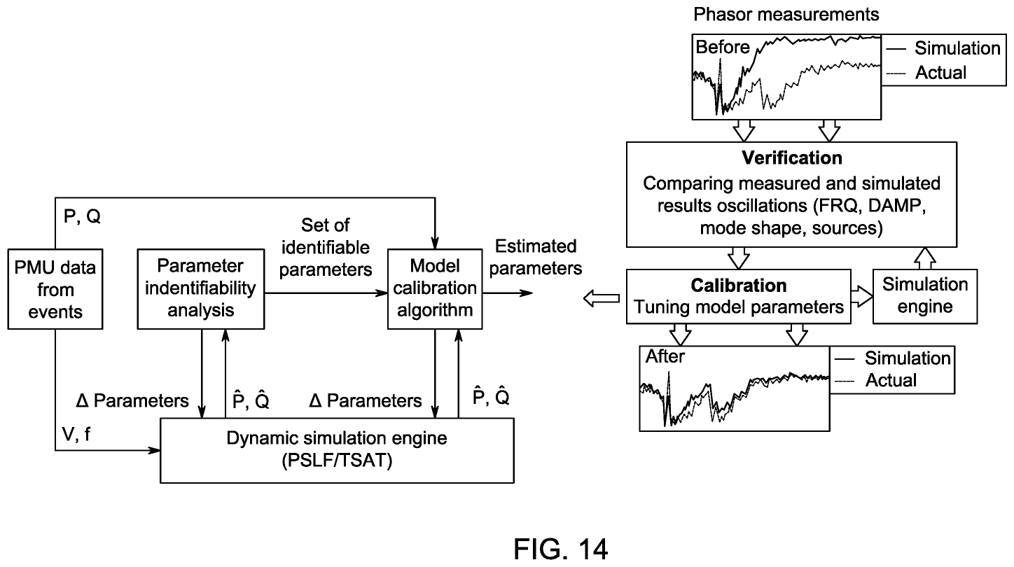

FIG. 14 illustrates a two-stage approach of the process for model calibration. In this approach, PMU data from events is fed into a dynamic simulation engine. The dynamic simulation engine communicates with a parameter identifiability analysis component and returns the changes to the parameters. The parameter identifiability analysis component also transmits a set of identifiable parameters to a model calibration algorithm component. The model calibration algorithm component uses the set of identifiable parameters, PMU data from events, and other data from the dynamic simulation engine to generate estimated parameters. This approach may be used to calibrate the tuning model parameters.

With the playback simulation capability, the user can compare the response (active power and reactive power) of system models with dynamics observed during disturbances in the system, which is called model validation. The grid disturbance (aka. events) can also be used to correct the system model when simulated response is significantly different from the measured values, which is called model calibration. As shown in the right side of the FIG. 14, the goal is to achieve a satisfactory match between the measurement data and simulated response. If obvious a discrepancy is observed, then the model calibration process may be employed.

The first step of the model calibration process is parameter identification, which aims to identify a subset of parameters with strong sensitivity to the observed event. In the exemplary embodiment, the model calibration process requires a balance on matching in measurement space and reasonableness in the model parameter space. Numerical curve fitting without adequate engineering guidance tends to provide overfitted parameter results, and leads to non-unique sets of parameters (leading to same curve fitting performance), which should be avoided.

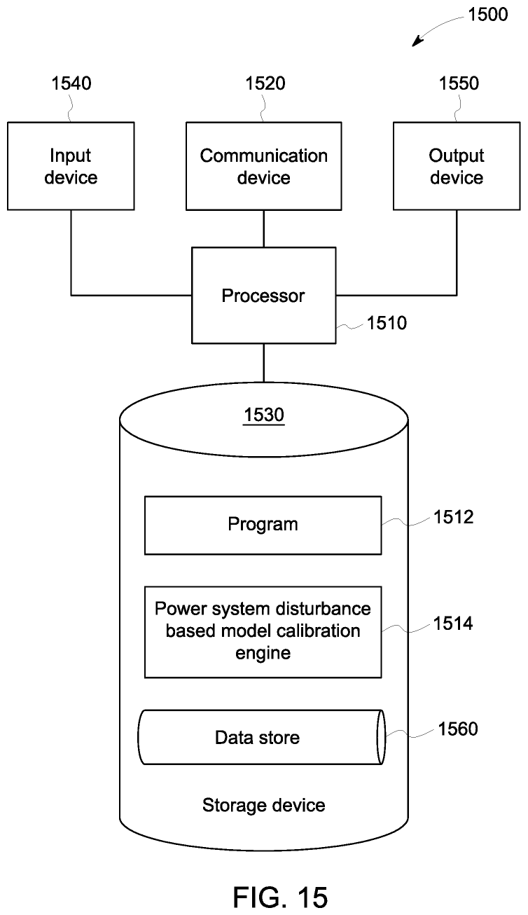

The embodiments described herein may also be implemented using any number of different hardware configurations. For example, FIG. 15 is a block diagram of an apparatus or platform 1500 that may be, for example, associated with the system 200 of FIG. 2 and/or any other system described herein. The platform 1500 comprises a processor 1510, such as one or more commercially available Central Processing Units (“CPUs”) in the form of one-chip microprocessors, coupled to a communication device 1520 configured to communicate via a communication network (not shown in FIG. 15). The communication device 1520 may be used to communicate, for example, with one or more remote measurement units, components, user interfaces, etc. The platform 1500 further includes an input device 1540 (e.g., a computer mouse and/or keyboard to input power grid and/or modeling information) and/an output device 1550 (e.g., a computer monitor to render a display, provide alerts, transmit recommendations, and/or create reports). According to some embodiments, a mobile device, monitoring physical system, and/or PC may be used to exchange information with the platform 1500.

The processor 1510 also communicates with a storage device 1530. The storage device 1530 may comprise any appropriate information storage device, including combinations of magnetic storage devices (e.g., a hard disk drive), optical storage devices, mobile telephones, and/or semiconductor memory devices. The storage device 1530 stores a program 1512 and/or a power system disturbance based model calibration engine 1514 for controlling the processor 1510. The processor 1510 performs instructions of the programs 1512, 1514, and thereby operates in accordance with any of the embodiments described herein. For example, the processor 1510 may calibrate a dynamic simulation engine, having system parameters, associated with a component of an electrical power system (e.g., a generator, wind turbine, etc.). The processor 1510 may receive, from a measurement data store 1560, measurement data measured by an electrical power system measurement unit (e.g., a phasor measurement unit, digital fault recorder, or other means of measuring frequency, voltage, current, or power phasors). The processor 1510 may then pre-condition the measurement data and set-up an optimization problem based on a result of the pre-conditioning. The system parameters of the dynamic simulation engine may be determined by solving the optimization problem with an iterative method until at least one convergence criteria is met. According to some embodiments, solving the optimization problem includes a Jacobian approximation that does not call the dynamic simulation engine if an improvement of residual meets a pre-defined criterion.

The programs 1512, 1514 may be stored in a compressed, uncompiled and/or encrypted format. The programs 1512, 1514 may furthermore include other program elements, such as an operating system, clipboard application, a database management system, and/or device drivers used by the processor 1510 to interface with peripheral devices.

As used herein, information may be “received” by or “transmitted” to, for example: (i) the platform 1500 from another device; or (ii) a software application or module within the platform 1500 from another software application, module, or any other source.

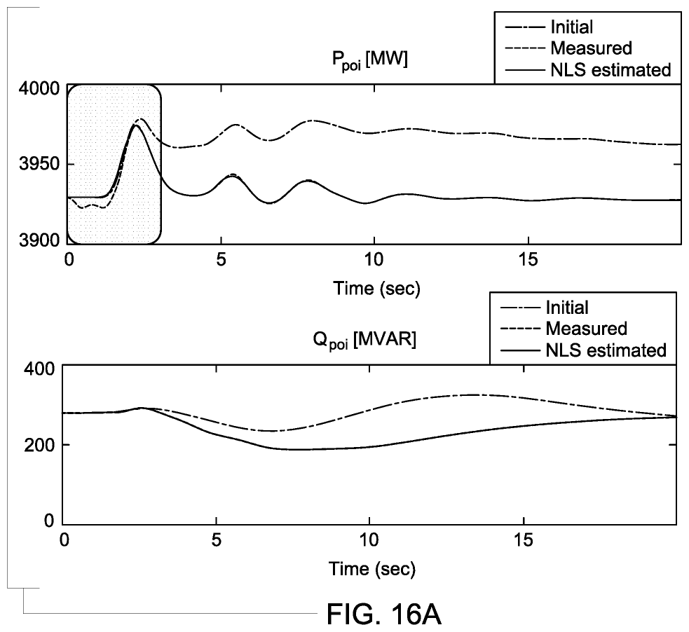

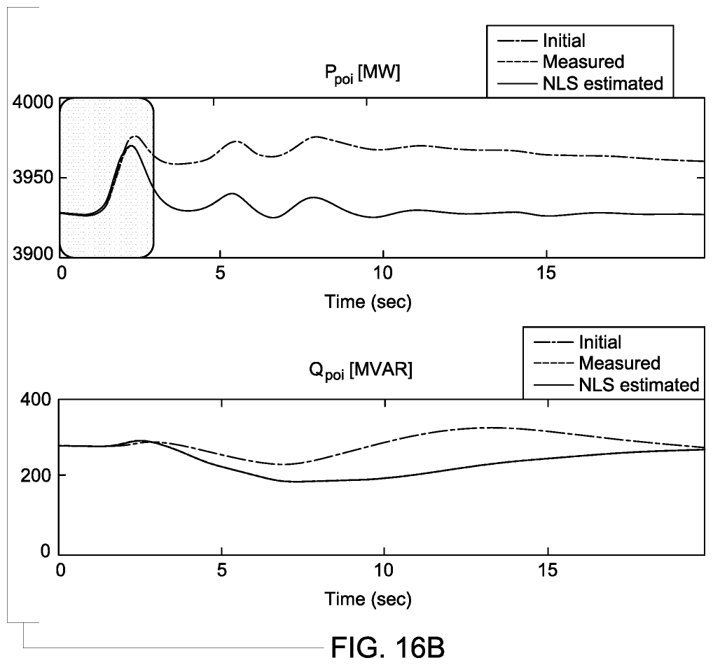

FIGS. 16A and 16B illustrate exemplary graphs of active and reactive power before and after calibration using the system 300 (shown in FIG. 3). FIG. 16A illustrates the active and reactive power curves for an event prior to calibration. FIG. 16B illustrates the active and reactive power curves for the same event after the parameters have been identified and tuned and the system 300 has performed the calculations described above. At the beginning of each of the active power curves is a defined region. In the region in FIG. 16A, there is a noticeable difference between the measured and estimated curves. In FIG. 16B, this difference has been rectified using the systems and methods described herein.

Besides of the benefit of achieving a better response curve fitting at regions of interest, the reasonableness of the model parameters identified has been significantly improved using the systems and methods described. In one example, the number of parameters tuned to achieve the same curve fitting performance has been reduce from 17 to 7 or 3, which makes this solution closer to what the industry user expects.

In some other embodiments, the system 300 (shown in FIG. 3) receives event data 308 (shown in FIG. 3) and model response data associated with a model 302 and 306 (both shown in FIG. 3) to simulate. The system 300 identifies a first region of a first event. The system 300 determines a first weight for the first region. The system 300 assigns a second weight to a second region of the first event. In the exemplary embodiment, the first region and the second region are different. The first weight and the second weight are different. The system 300 evaluates the model based on the first event including the first weight and the second weight.

In some embodiments, the first region includes a plurality of points in time and the first weight is associated with the plurality of points in time. In some other embodiments, the first weight is associated with a first portion of the plurality of points in time. In these embodiments, a third weight is associated with a second portion of the plurality of points in time associated with the first event.

In some embodiments the first event includes a first curve and a second curve and the system 300 identifies the first region of the first event based on the first curve and the second curve. The first curve may be one of an active power curve and a frequency curve and the second curve may be one of a reactive power curve and a voltage curve. In some further embodiments, the system 300 identifies a first curve region based on the first curve and a second curve region based on the second curve. The system 300 compares the first curve region and the second curve region to identify the first region. In still further embodiments, the system 300 analyzes the first curve to identify at least one potential event starting point and at least one potential event ending point. In some embodiments, the system 300 utilizes at least one of changepoint analysis and minimum volume enclosing ellipsoid to identify the first region.

In some embodiments, the system 300 presents, to a user via a user interface, at least one of the first region and the first weight. The system 300 receives, from the user via the user interface, an adjustment to one of the first region and the first weight. The system 300 then uses that adjustment in evaluating the model.

In some further embodiments, the system 300 executes at least one simulation of the model based on the first event. The system 300 compares results of the at least one simulation to the event data. Then the system 300 identifies the first region based on the comparison.

In some of the embodiments, the first event includes a plurality of points in time. The system 300 executes at least one simulation of the model based on the first event. The system 300 compare results of the at least one simulation to the event data. Then the system 300 determines an amount of error for each of the plurality of points in time. The system 300 identifies the first region by analyzing the amounts of error for the plurality of points in time.

In the exemplary embodiment, the system 300 validates the model. The system 300 identifies a plurality of tunable parameters based on the event data and the model response data. Where the model includes a plurality of parameters, the system 300 identifies the plurality of tunable parameters based on a difference between the event data and model response data with estimated model parameters. The system 300 generates a score for each of the plurality of parameters based on the difference between the event data and model response data with estimated model parameters and a Jacobian matrix corresponding to model response data. In some further embodiments, the system generates the score based on a dot product angle between the difference the event data and model response data and components of the Jacobian matrix. In still further embodiments, the system 300 selects the plurality of tunable parameters based on the dot product angle not exceeding a threshold.

At least one of the technical solutions to the technical problems provided by this system may include: (i) improved speed in modeling parameters; (ii) more robust models in response to measurement noise; (iii) compliance with NERC mandated grid reliability requirements; (iv) reduce the chance that an important parameter is not updated; (v) improved accuracy in parameter identifiability; (vi) improved accuracy in parameter estimation; and (vii) improved optimization of parameters based on event training.

The methods and systems described herein may be implemented using computer programming or engineering techniques including computer software, firmware, hardware, or any combination or subset thereof, wherein the technical effects may be achieved by performing at least one of the following steps: (a) receive event data and model response data associated with a model to simulate; (b) identify a first region of a first event, wherein first event includes a first curve and a second curve; (c) determine a first weight for the first region, wherein the first region includes a plurality of points in time, wherein the first weight is associated with the plurality of points in time or a first portion of the plurality of points in time, and wherein a third weight is associated with a second portion of the plurality of points in time associated with the first event; (d) assign a second weight to a second region of the first event, wherein the first region and the second region are different and wherein the first weight and the second weight are different; (e) evaluate the model based on the first event including the first weight and the second weight; (f) identify the first region of the first event based on the first curve and the second curve, wherein the first curve is one of an active power curve and a frequency curve and wherein the second curve is one of a reactive power curve and a voltage curve; (g) identify a first curve region based on the first curve; (h) identify a second curve region based on the second curve; (i) compare the first curve region and the second curve region to identify the first region; (j) analyze the first curve to identify at least one potential event starting point and at least one potential event ending point; (k) utilize at least one of changepoint analysis and minimum volume enclosing ellipsoid to identify the first region; (l) present, to a user via a user interface, at least one of the first region and the first weight; (m) receive, from the user via the user interface, an adjustment to one of the first region and the first weight; (n) execute at least one simulation of the model based on the first event; (o) compare results of the at least one simulation to the event data; (p) identify the first region based on the comparison; (q) execute at least one simulation of the model based on the first event; (r) compare results of the at least one simulation to the event data; (s) determine an amount of error for each of the plurality of points in time; (t) identify the first region by analyzing the amounts of error for the plurality of points in time; and (u) validate the model.

In other embodiments, the technical effects may be achieved by performing at least one of the following steps: (a) identify a plurality of tunable parameters based on the event data and the model response data; (b) identify the plurality of tunable parameters based on a difference between the event data and model response data with estimated model parameters; (c) generate a score for each of the plurality of parameters based on the difference between the event data and model response data with estimated model parameters and a Jacobian matrix corresponding to model response data; (d) generate the score based on a dot product angle between the difference the event data and model response data and components of the Jacobian matrix; and (e) select the plurality of tunable parameters based on the dot product angle not exceeding a threshold.

In still other embodiments, the technical effects may be achieved by performing at least one of the following steps: (a) receiving event data and model response data associated with a model to simulate; (b) identifying a first region of a first event, wherein the first event includes an active power curve and a reactive power curve; (c) determining a first weight for a first portion of the first region, wherein the first region includes a plurality of points in time and wherein the first weight is associated with a first portion of the plurality of points in time; (d) determining a second weight for a second portion of the first region, wherein the first weight and the second weight are different and wherein the first portion is associated with the active power curve and the second portion is associated with reactive power curve; and (e) evaluating the model based on the first event including the first portion and the first weight and the second portion and the second weight.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing sensor data, and detecting abnormalities.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment,” “exemplary embodiment,” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for enhanced power system model calibration comprising a computing device including at least one processor in communication with at least one memory device, wherein the at least one processor is programmed to:
receive event data and model response data associated with a model to simulate;
identify a first region of a first event;
determine a first weight for the first region;
assign a second weight to a second region of the first event, wherein the first region and the second region are different and wherein the first weight and the second weight are different; and
evaluate the model based on the first event including the first weight and the second weight.

2. The system in accordance with claim 1, wherein the first region includes a plurality of points in time and wherein the first weight is associated with the plurality of points in time.

3. The system in accordance with claim 1, wherein the first region includes a plurality of points in time and wherein the first weight is associated with a first portion of the plurality of points in time.

4. The system in accordance with claim 3, wherein a third weight is associated with a second portion of the plurality of points in time associated with the first event.

5. The system in accordance with claim 1, wherein the first event includes a first curve and a second curve, and wherein the at least one processor is further programmed to identify the first region of the first event based on the first curve and the second curve.

6. The system in accordance with claim 5, wherein the first curve is one of an active power curve and a frequency curve and wherein the second curve is one of a reactive power curve and a voltage curve.

7. The system in accordance with claim 5, wherein the at least one processor is further programmed to:
identify a first curve region based on the first curve;
identify a second curve region based on the second curve; and
compare the first curve region and the second curve region to identify the first region.

8. The system in accordance with claim 7, wherein the at least one processor is further programmed to analyze the first curve to identify at least one potential event starting point and at least one potential event ending point.

9. The system in accordance with claim 1, wherein the at least one processor is further programmed to utilize at least one of changepoint analysis and minimum volume enclosing ellipsoid to identify the first region.

10. The system in accordance with claim 1, wherein the at least one processor is further programmed to:
present, to a user via a user interface, at least one of the first region and the first weight; and
receive, from the user via the user interface, an adjustment to one of the first region and the first weight.

11. The system in accordance with claim 1, wherein the at least one processor is further programmed to:
execute at least one simulation of the model based on the first event;
compare results of the at least one simulation to the event data; and
identify the first region based on the comparison.

12. The system in accordance with claim 1, wherein the first event includes a plurality of points in time and wherein the at least one processor is further programmed to:
execute at least one simulation of the model based on the first event;
compare results of the at least one simulation to the event data; and
determine an amount of error for each of the plurality of points in time.

13. The system in accordance with claim 12, wherein the at least one processor is further programmed to identify the first region by analyzing the amounts of error for the plurality of points in time.

14. The system in accordance with claim 1, wherein the at least one processor is further programmed to validate the model.

15. The system in accordance with claim 1, wherein the at least one processor is further programmed to identify a plurality of tunable parameters based on the event data and the model response data.

16. The system in accordance with claim 15, wherein the model includes a plurality of parameters, and wherein the at least one processor is further programmed to identify the plurality of tunable parameters based on a difference between the event data and model response data with estimated model parameters.

17. The system in accordance with claim 16, wherein the at least one processor is further programmed to generate a score for each of the plurality of parameters based on the difference between the event data and model response data with estimated model parameters and a Jacobian matrix corresponding to model response data.

18. The system in accordance with claim 17, wherein the at least one processor is further programmed to generate the score based on a dot product angle between the difference the event data and model response data and components of the Jacobian matrix.

19. The system in accordance with claim 18, wherein the at least one processor is further programmed to select the plurality of tunable parameters based on the dot product angle not exceeding a threshold.

20. A method for enhanced power system model calibration, the method implemented on a computing device including at least one processor in communication with at least one memory device, the method comprises:
receiving event data and model response data associated with a model to simulate;
identifying a first region of a first event, wherein the first event includes an active power curve and a reactive power curve;
determining a first weight for a first portion of the first region, wherein the first region includes a plurality of points in time and wherein the first weight is associated with a first portion of the plurality of points in time;
determining a second weight for a second portion of the first region, wherein the first weight and the second weight are different and wherein the first portion is associated with the active power curve and the second portion is associated with reactive power curve; and
evaluating the model based on the first event including the first portion and the first weight and the second portion and the second weight.
